(19) United States
(12) Patent Application Publication
(10) Pub. No.: US 2025/0392949 A1
(43) Pub. Date: Dec. 25, 2025

(54) METHODS AND APPARATUSES FOR A BUFFER STATUS REPORT

(71) Applicant: LENOVO (BEIJING) LIMITED, Beijing (CN)

(72) Inventors: Xiaoying XU, Beijing (CN); Mingzeng DAI, Shanghai (CN); Jing HAN, Beijing (CN); Lianhai WU, Beijing (CN)

(21) Appl. No.: 18/879,602

(22) PCT Filed: Jun. 30, 2022
(86) PCT No.: PCT/CN2022/102962

§ 371 Date: Dec. 27, 2024

(51) Int. Cl. H04W 28/02

(52) U.S. Cl. CPC H04W 28/0278

(57) ABSTRACT

Embodiments of the subject application relate to methods and apparatuses for a buffer status report (BSR). According to an embodiment of the subject application, a user equipment (UE) includes a processor and a transceiver coupled to the processor; and the processor is configured to: receive, via the transceiver from a network, a configuration for enabling a function of an enhanced buffer status report (EBSR); and transmit the EBSR via the transceiver to the network.

### TECHNICAL FIELD

Embodiments of the subject application generally relate to wireless communication technology, in particular to methods and apparatuses for a buffer status report (BSR).

### BACKGROUND

Extended reality (XR), including augmented reality (AR) and virtual reality (VR), as well as cloud gaming (CG), presents a new promising category of connected devices, applications, and services. As a potential working area of 3GPP (3rd generation partnership project) Rel-18, application and traffic awareness in radio access network (RAN) is one of key feature to improve user experience of XR services. Currently, details regarding a BSR associated with a PDU set (e.g., a frame) for XR traffic have not been discussed yet.

### SUMMARY

Some embodiments of the subject application also provide a user equipment (UE). The UE includes a processor and a transceiver coupled to the processor; and the processor is configured to: receive, via the transceiver from a network, a first configuration for enabling a function of an enhanced buffer status report (EBSR); and transmit the EBSR via the transceiver to the network.

In some embodiments, the EBSR includes at least one of: a first field including one buffer size (BS) index, wherein a buffer size indicated by the one BS index of the first field represents an uplink (UL) data volume for transmission in one or more logical channel groups (LCGs) or in one or more logical channels (LCHs); or a second field including two or more BS indexes, wherein a sum of buffer sizes indicated by the two or more BS indexes of the second field represents the UL data volume for transmission in the one or more LCGs or in the one or more LCHs; or an third field indicating a presence of the second field for the one or more LCGs or for the one or more LCHs.

In some embodiments, the one BS index is included in a first BS table, wherein each BS index in the two or more BS indexes is included in one BS table or in two or more BS tables.

In some embodiments, the processor of the UE is configured to receive a second configuration via the transceiver from the network, and wherein the second configuration indicates at least one of: a first set of LCGs or a first set of LCHs which can use the first field in the EBSR; or a second set of LCGs or a second set of LCHs which can use the second field in the EBSR.

In some embodiments, the processor of the UE is configured to: select at least one of the first field and the second field to be used in the EBSR for an LCG or an LCH; and transmit an indication for indicating that the at least one of the first field and the second field is used in the EBSR for the LCG or the LCH via the transceiver to the network.

In some embodiments, to select the at least one of the first field and the second field, the processor of the UE is configured to: determine whether a difference between the UL data volume and the buffer size indicated by the one BS index is greater than or equal to a threshold; select the second field to be used in the EBSR, in response to determining that the difference is greater than or equal to the threshold; and select the first field to be used in the EBSR, in response to determining that the difference is less than the threshold.

In some embodiments, the processor of the UE is configured to receive a third configuration related to one or more BS tables for an LCG or an LCH via the transceiver from the network, and wherein a BS index included in the EBSR is selected from the one or more BS tables.

In some embodiments, the processor of the UE is configured to receive, via the transceiver from the network, at least one of: a deactivation command to stop using a BS table within the one or more BS tables for the LCG or the LCH; or an activation command to use the BS table for the LCG or the LCH.

In some embodiments, the processor of the UE is configured to: suspend the function of the EBSR (for the LCG or the LCH using the BS table indicated by the command) immediately or after first time duration upon reception of the deactivation command; or resume the function of the EBSR (for the LCG or the LCH using the BS table indicated by the command) immediately or after second time duration upon reception of the activation command.

In some embodiments, the processor of the UE is configured to transmit, via the transceiver to the network, one of: a confirmation of the deactivation command; and a confirmation of the activation command.

In some embodiments, at least one of the deactivation command or the activation command is received in one of: a medium access control (MAC) control element (CE); and downlink control information (DCI).

In some embodiments, at least one of the deactivation command or the activation command includes one of: at least one of: a table information of the BS table, or an ID of the LCG; at least one of: the table information of the BS table, or an ID of the LCH; and a bitmap corresponding to the one or more BS tables, to indicate that the BS table is deactivated or activated for the LCG or the LCH.

In some embodiments, a MAC sub-protocol data unit (PDU) including the EBSR indicates table information of a BS table used for the EBSR, and wherein the table information of the BS table is indicated by at least one of: an LCID field in a subheader of the MAC sub-PDU; or a field different from the LCID field in the subheader.

In some embodiments, the processor of the UE is configured to receive, via the transceiver from the network, a fourth configuration related to mapping relation between a value in the LCID field and the table information of the BS table.

In some embodiments, mapping relation between a value in the LCID field and the table information of the BS table is predefined by a specification.

In some embodiments, the processor of the UE is configured to: set a value of a fourth field in the EBSR as a specific value; and set a value of a fifth field in the EBSR to indicate a UL data volume, wherein the value of the fourth field is included in a BS table for an LCG or an LCH.

In some embodiments, the EBSR includes at least one of: one or more delay information (DI) fields including delay information associated with one or more protocol data unit (PDU) sets; or one or more BS fields including one or more BS indexes associated with the delay information.

In some embodiments, one or more buffer sizes indicated by the one or more BS indexes represents: a total amount of data available for transmission in the one or more PDU sets corresponding to the delay information; or a total amount of data available for transmission in an LCH; or a total amount of data available for transmission across all LCHs of an LCG.

In some embodiments, the delay information includes at least one of: a remaining PDU set delay budget; a PDU set buffer delay; a PDU set delay budget offset; or first timing when receiving a PDU within the one or more PDU sets from an upper layer of the UE.

In some embodiments, the delay information includes first delay information associated with a first arrival PDU or a last arrival PDU of one PDU set within the one or more PDU sets.

In some embodiments, the remaining PDU set delay budget corresponds to one PDU set with a minimum delay budget within the one or more PDU sets; the PDU set buffer delay corresponds to one PDU set with a maximum buffer delay within the one or more PDU sets; or the first timing corresponds to one PDU set with earliest arriving timing within the one or more PDU sets.

In some embodiments, the delay information includes second delay information corresponding to one PDU set with a highest priority logical channel within the one or more PDU sets, and wherein the highest priority logical channel is allowed to report the second delay information in an LCG or in a MAC entity of the UE or in the UE.

In some embodiments, the delay information includes at least one of: third delay information corresponding to one PDU set within the one or more PDU sets in an LCH with or without data available for transmission; or fourth delay information corresponding to one PDU set within the one or more PDU sets in an LCG with or without data available for transmission.

In some embodiments, the one or more DI fields and the one or more BS fields for an LCH or an LCG are interleaved in the EBSR to form one or more pairs of DI fields and BS fields.

In some embodiments, the one or more DI fields within the one or more pairs for the LCH or the LCG are ordered: in an ascending order based on a remaining PDU set delay budget; in a decreasing order based on a PDU set buffer delay; in an ascending order based on arriving timing at an access stratum (AS) layer of the UE of a first arrival PDU; or in an ascending order based on arriving timing at the AS layer of the UE of a last arrival PDU.

In some embodiments, in response to allocated uplink (UL) resources being not sufficient to accommodate the one or more pairs in the EBSR for one or more LCHs or one or more LCGs, the processor of the UE is configured to: prioritize the one or more pairs in a decreasing order of priorities of the one or more LCHs; prioritize the one or more pairs in a decreasing order of a highest priority logical channel in each of the one or more LCGs; or in case that the one or more pairs have an equal logical channel priority, prioritize the one or more pairs in an increasing order or a decreasing order of the value of the delay information, wherein the allocated UL resources include a part of the prioritized one or more pairs.

Some embodiments of the subject application also provide a network node (e.g., a base station). The network node includes a processor and a transceiver coupled to the processor; and the processor is configured to: transmit, via the transceiver to a user equipment (UE), a first configuration for enabling a function of an enhanced buffer status report (EBSR); and receive the EBSR via the transceiver from the UE.

In some embodiments, the EBSR includes at least one of: a first field including one BS index, wherein a buffer size of the first field indicated by the one BS index represents an uplink (UL) data volume for transmission in one or more logical channel groups (LCGs) or in one or more logical channels (LCHs); or a second field including two or more BS indexes, wherein a sum of buffer sizes indicated by the two or more BS indexes of the second field represents the UL data volume for transmission in the one or more LCGs or in the one or more LCHs; or a third field indicating a presence of the second field for the one or more LCGs or for the one or more LCHs.

In some embodiments, the one BS index is included in a first BS table, wherein each BS index in the two or more BS indexes is included in one BS table or in two or more BS tables.

In some embodiments, the processor of the network node is configured to transmit a second configuration via the transceiver to the UE, and wherein the second configuration indicates at least one of: a first set of LCGs or a first set of LCHs which can use the first field in the EBSR; or a second set of LCGs or a second set of LCHs which can use the second field in the EBSR.

In some embodiments, the processor of the network node is configured to transmit a third configuration related to one or more BS tables for an LCG or an LCH via the transceiver to the UE, and wherein a BS index included in the EBSR is selected from the one or more BS tables.

In some embodiments, the processor of the network node is configured to transmit, via the transceiver to the UE, at least one of: a deactivation command to stop using a BS table within the one or more BS tables for the LCG or the LCH; or an activation command to use the BS table for the LCG or the LCH.

In some embodiments, the processor of the network node is configured to receive, via the transceiver from the UE, one of: a confirmation of the deactivation command; and a confirmation of the activation command.

In some embodiments, at least one of the deactivation command or the activation command is transmitted in one of: a medium access control (MAC) control element (CE); and downlink control information (DCI).

In some embodiments, at least one of the deactivation command or the activation command includes one of: at least one of: table information of the BS table, or an ID of the LCG; at least one of: the table information of the BS table, or an ID of the LCH; and a bitmap corresponding to the one or more BS tables, to indicate that the BS table is deactivated or activated for the LCG or the LCH.

Some embodiments of the subject application provide a method, which may be performed by a UE. The method includes: receiving, from a network, a configuration for enabling a function of an enhanced buffer status report (EBSR); and transmitting the EBSR to the network.

Some embodiments of the subject application provide a method, which may be performed by a network node (e.g., a base station). The method includes: transmitting, to a user equipment (UE), a configuration for enabling a function of an enhanced buffer status report (EBSR); and receiving the EBSR from the UE.

Some embodiments of the subject application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE or a network node (e.g., a base station).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1A illustrates a schematic diagram of a wireless communication system in accordance with some embodiments of the subject application.

FIG. 1B illustrates an exemplary schematic diagram of a PDU set delay budget of XR traffic in accordance with some embodiments of the subject application.

FIG. 2 illustrates an exemplary flowchart for transmitting an EBSR in accordance with some embodiments of the subject application.

FIG. 3 illustrates a further exemplary flowchart for receiving an EBSR in accordance with some embodiments of the subject application.

FIGS. 4-18 illustrate exemplary MAC PDUs related to an EBSR in accordance with some embodiments of the subject application.

FIG. 19 illustrates an exemplary block diagram of an apparatus for a delay status report in accordance with some embodiments of the subject application.

FIG. 20 illustrates a further exemplary block diagram of an apparatus for a delay status report in accordance with some embodiments of the subject application.

### DETAILED DESCRIPTION

The detailed description of the appended drawings is intended as a description of preferred embodiments of the subject application and is not intended to represent the only form in which the subject application may be practiced. It should be understood that the same or equivalent functions may be accomplished by different embodiments that are intended to be encompassed within the spirit and scope of the subject application.

Reference will now be made in detail to some embodiments of the subject application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the subject application are also applicable to similar technical problems; and moreover, the terminologies recited in the subject application may change, which should not affect the principle of the subject application.

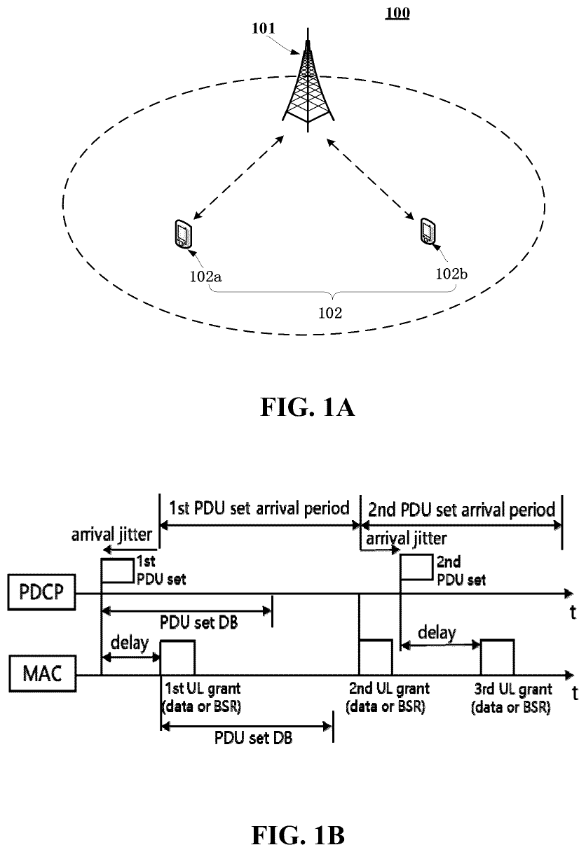

FIG. 1A illustrates a schematic diagram of a wireless communication system in accordance with some embodiments of the subject application. As shown in FIG. 1A, the wireless communication system 100 includes at least one base station 101 and at least one UE 102. In particular, the wireless communication system 100 includes one BS 101 and two UEs 102 (e.g., a UE 102a and a UE 102b) for illustrative purpose. Although a specific number of BS 101 and UEs 102 are depicted in FIG. 1A, it is contemplated that any number of BSs 101 and UEs 102 may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may also be referred to as a NG-RAN node, a RAN node, an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to BS 101.

According to some embodiments of the subject application, UE(s) 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some other embodiments of the subject application, UE(s) 102 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the subject application, UE(s) 102 may include wearable devices, such as smart watches, fitness bands, optical head-mounted displays, or the like. Moreover, UE(s) 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

Both UE 102a and UE 102b in the embodiments of FIG. 1A may transmit information to BS 101 and receive control information from BS 101, for example, via LTE or NR Uu interface.

As defined in 3GPP TR23.700-60, a new quality of service (QOS) parameter associated with PDU-Set is PDU-Set Delay Budget (PSDB), which defines an upper bound for the time that a PDU-Set may be delayed between a UE and the N6 termination point at the UPF. PSDB applies to the DL PDU-Set received by the UPF over the N6 interface, and to the UL PDU-Set sent by the UE. For a certain 5QI the value of the PSDB is the same in UL and DL. In the case of 3GPP access, the PSDB is used to support the configuration of scheduling and link layer functions (e.g., the setting of scheduling priority weights and HARQ target operating points).

According to 3GPP TR23.700-60, the 5G Access Network PDU-Set Delay Budget (5G-AN PSDB) is determined by subtracting a static value for the Core Network PDU-Set Delay Budget (CN PSDB), which represents the delay between any N6 termination point at the UPF (for any UPF that may possibly be selected for the PDU Session) and the 5G-AN from a given PSDB.

As defined in 3GPP TS38.323, regarding a service data unit (SDU) discard operation, when the discard timer expires for a PDCP SDU, or the successful delivery of a PDCP SDU is confirmed by a PDCP status report, the transmitting PDCP entity shall discard the PDCP SDU along with the corresponding PDCP Data PDU. If the corresponding PDCP Data PDU has already been submitted to lower layers, the discard is indicated to lower layers. For signaling radio bearers (SRBs), when upper layers request a PDCP SDU discard, the PDCP entity shall discard all stored PDCP SDUs and PDCP PDUs.

As defined in 3GPP TR23.501, the Packet Delay Budget (PDB) defines an upper bound for the time that a packet may be delayed between the UE and the N6termination point at the UPF. The PDB applies to the DL packet received by the UPF over the N6 interface, and to the UL packet sent by the UE. For a certain 5QI the value of the PDB is the same in UL and DL. In the case of 3GPP access, the PDB is used to support the configuration of scheduling and link layer functions (e.g. the setting of scheduling priority weights and HARQ target operating points). The 5G Access Network Packet Delay Budget (5G-AN PDB) is determined by subtracting a static value for the Core Network Packet Delay Budget (CN PDB), which represents the delay between any N6 termination point at the UPF and the 5G-AN from a given PDB.

In general, XR, including AR and VR, as well as CG, presents a new promising category of connected devices, applications, and services. A UE with an XR service can be referred to as an XR device. XR-specific capacity improvements are key features. For example, there is a need to study mechanisms that provide more efficient resource allocation and scheduling for XR service characteristics (e.g., periodicity, multiple flows, jitter, latency, reliability, etc.). Typically, an issue which may impact the system capacity is that a network allocates over resources due to a buffer size value associated with the buffer size with the large granularity.

As defined in 3GPP TS38.321, one legacy buffer size table, includes buffer size levels (in bytes) for 5-bit buffer size field, i.e., Table 6.1.3.1-1, and another legacy buffer size table includes buffer size levels (in bytes) for 8-bit buffer size field, i.e., Table 6.1.3.1-2. For instance, in the 5-bit buffer size field, BS index 0 represents a buffer size value 0, BS index 8 represents a buffer size value less than or equal to 102, BS index 9 represents a buffer size value less than or equal to 142, BS index 29 represents a buffer size value less than or equal to 107669, BS index 30 represents a buffer size value less than or equal to 150000, and etc. In the 8-bit Buffer Size field, BS index 134 represents a buffer size value of 45709, BS index 135 represents a buffer size value less than or equal to 48676, BS index 146 represents a buffer size value less than or equal to 97221, BS index 251 represents a buffer size value less than or equal to 71724679, BS index 252 represents a buffer size value less than or equal to 76380419, BS index 253 represents a buffer size value less than or equal to 81338368, and etc.

For example, supposing that the legacy buffer size table includes buffer size levels (in bytes) for 8-bit buffer size field is used, if a maximun value of I size is 46261 bytes and a maximun value of P size is 30840 bytes, the buffer size index needs to be set as 135 which represents that buffer size value less than or equal to 48676bytes. However, I size quantization error between 46261 bytes and 48676 bytes is 2415 bytes. That is, the buffere size of 2415 bytes are wasted. If a maximun value of I size is 92521 bytes and a maximun value of P size is 61681 bytes, the buffer size index needs to be set as 146 which represents that buffer size value less than or equal to 97221 bytes. However, I size quantization error between 92521 bytes and 97221bytes is 4700 bytes. That is, the buffere size of 4700 bytes are wasted.

As can be seen, the current buffer size report granularity is large, and the accurate buffer status cannot be reflected in the BSR. It brings several thousand uncertainties especially when the buffer size value is above 20000 bytes. This causes the over resource allocated for a UL transmission of XR traffic.

Another issue which may impact the system capacity is that a network is unaware of the accurate buffer delay for uplink (UL) PDU set schedule optimization due to the mismatched configured grant (CG) and a BSR transmission due to UL jitter of arrival time at the UE. Generally, the network determines the PDB duration from the expected PDU set periodic arrival time or BSR receiving timing. However, the network is not aware of the delay time of the data or BSR transmission(s) due to the mismatch between CG and early arrival XR burst. Thus, the network cannot determine the buffer delayed time and perform the good scheduling policy to avoid exceeding the PDU set delay budget. A specific example is described in embodiments of FIG. 1B.

FIG. 1B illustrates an exemplary schematic diagram of a PDU set delay budget of XR traffic in accordance with some embodiments of the subject application. In the embodiments of FIG. 1B, PDU set(s) in PDU set arrival period(s) may arrive at a PDCP layer of a UE with arrival jitter. As shown in FIG. 1B, 1st PDU set in 1st PDU set arrival period arrives with negative arrival jitter, and 2nd PDU set in 2nd PDU set arrival period arrives with positive arrival jitter in time domain. Thus, there is buffer delay between the arrival timing of the PDU set in 1st PDU set arrival period and the timing of a UL grant of a MAC layer of the UE, e.g., “1st UL grant (of data or BSR for transmission of (the first PDU of) the PDU set)”, in time domain. There is delay between the arrival timing of the PDU set in 2nd PDU set arrival period and the timing of a UL grant, e.g., “3rd UL grant (of data or BSR for transmission of (the first PDU of) the PDU set)”, in time domain.

Since 1st PDU set in 1st PDU set arrival period arrives earlier in time domain, “PDU set DB (delay budget)” of 1st PDU set in 1st PDU set arrival period is different from the original or initial “PDU set DB” of 1st PDU set transmitted on 1st UL grant (of data or BSR for transmission of the PDU set), as shown in FIG. 1B. Similarly, since 2nd PDU set in 2nd PDU set arrival period arrives later in time domain, “PDU set DB” (not shown in FIG. 1B) of 2nd PDU set in 2nd PDU set arrival period is also different from the original or initial “PDU set DB” (not shown in FIG. 1B) of 2nd PDU set transmitted on 3rd UL grant in time domain.

To resolve the abovementioned issues, embodiments of the subject application design a mechanism for a delay status report associated with a PDU set for a UL transmission of XR traffic.

More specifically, some embodiments of the subject application introduce a mechanism to reduce a quantization error of a buffer size (BS) and improve a BSR granularity for a XR device for the capacity enhancement. In some embodiments, a UE may transmit an EBSR including a BS index combination, to indicate the UL data volume for transmission in an LCG or LCH by a sum of the buffer sizes corresponding to two BS identifiers in the same BS table or different BS tables. In some embodiments, a UE may transmit a BSR including a BS index selected from a BS table configured for an LCG or LCH by a network. In some embodiments, a UE may use a new LCID or another field in a MAC subheader of a BSR to indicate a new BS table used for the BSR, and the mapping between an LCID and a BS table may be configured by a network or predefined by a specification. In some embodiments, a UE may use a BS index of a specific value (e.g., 255) to indicate another field including the actual BS index in a new BS table for one LCG or an LCH. In some embodiments, a UE may include a table information field and BS field for one LCG or LCH, wherein the BS index in the BS field is in the table identified by the table information.

Some embodiments of the subject application introduce a mechanism to assist a network to determine an available or remaining or left delay budget corresponding to a PDU set (e.g., a frame) in an EBSR. In some embodiments, a UE may transmit a buffer size and delay information (DI) in an EBSR to a network. The DI may correspond to the first or the last PDU in a PDU set with the highest delay budget or with the lowest delay budget or with the earliest arriving timing at a AS layer of the first or last reception of a PDU in the PDU set with the highest priority logical channel in an LCG with or without data available for transmission (or with an LCH with or data without available for transmission). In some embodiments, the BS identifies a total amount of data available of a PDU set corresponding to “Delay” field corresponding to an LCG or a total amount of data available across all LCHs of an LCG. In some embodiments, if more than one pair of DI field and BS field for an LCH or for an LCG, “Delay” fields are included in an ascending order based on the delay budget or in a decreasing order based on the delay or in an ascending order based on arriving timing at the AS layer of the first or last reception of a PDU. For instance, the BS field of an LCG or an LCH corresponding to the DI field of the LCG or the LCH may be interleaved. For instance, the BS field corresponding to the DI field may be not interleaved, the BS fields of all LCGs or all LCHs are included together, the DI fields of all LCGs or all LCHs are included together. In some embodiments, if the UL grant is not enough to include all the EBSR of all LCHs or all LCGs, a UE may prioritize the EBSR including the pair of the BS field and DI filed in a decreasing order of the (highest) logical channel priority, and may optionally in a decreasing order of delay (or in an increasing order of the remaining delay budget, or in an increasing order of arriving timing at an AS layer of the first or last reception of a PDU). In some embodiments, if the UL grant is not enough to include all the EBSR of all LCHs or all LCGs, a UE may prioritize the BS field of the EBSR in a decreasing order of the (highest) logical channel priority, and then prioritize the DI field of the EBSR in a decreasing order of the (highest) logical channel priority. In some embodiments, if the UL grant is not enough to include all the EBSR of all LCHs or all LCGs, a UE may prioritize the DI field of the EBSR in a decreasing order of the (highest) logical channel priority, and then prioritize the BS field of the EBSR in a decreasing order of the (highest) logical channel priority. More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

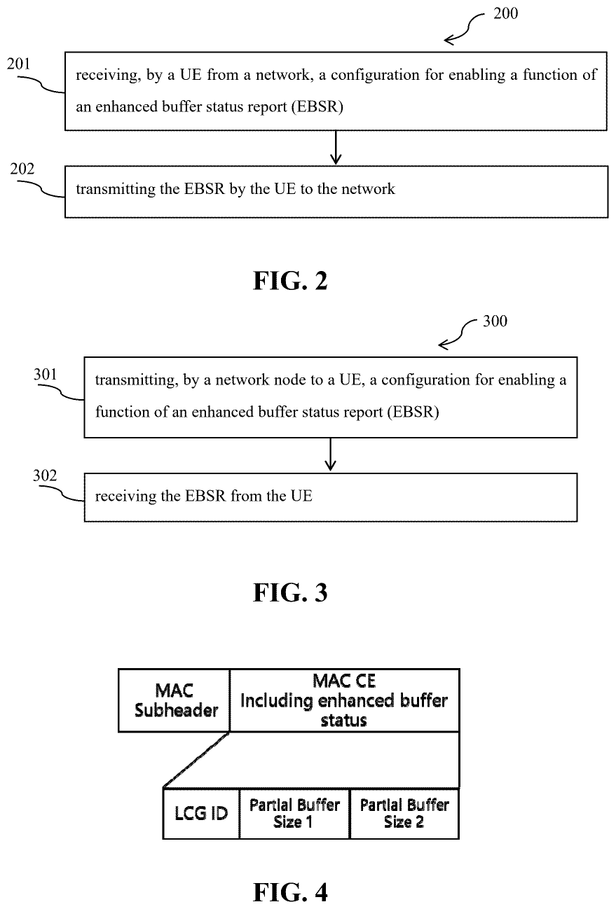

FIG. 2 illustrates an exemplary flowchart for transmitting an EBSR in accordance with some embodiments of the subject application. The exemplary method 200 in FIG. 2 may be performed by a UE, e.g., UE 102 as shown in FIG. 1A. Although described with respect to a UE, it should be understood that other devices may be configured to perform a method similar to that of FIG. 2.

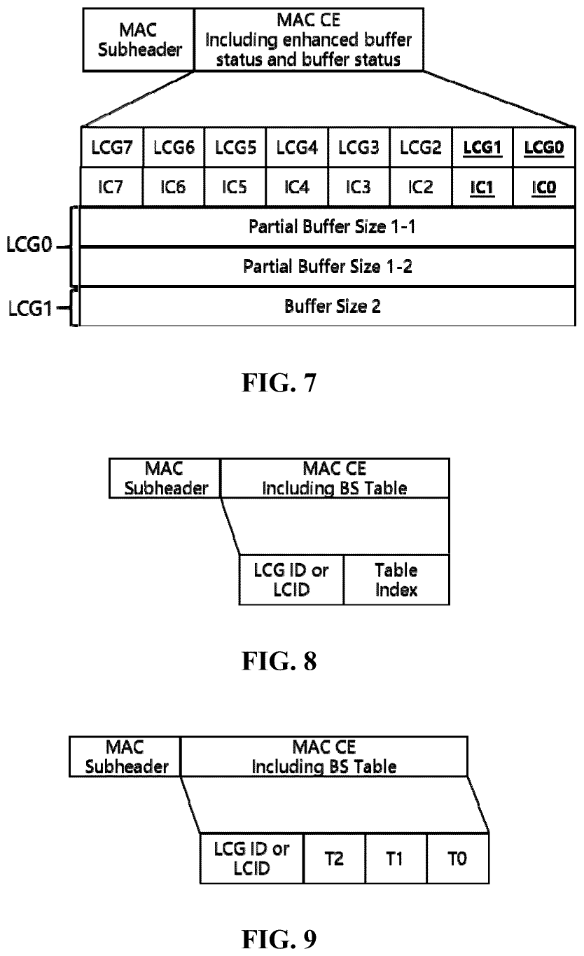

In the exemplary method 200 in FIG. 2, in operation 201, a UE receives, from a network, a configuration for enabling a function of an EBSR. In operation 202, the UE transmits the EBSR to the network. In some embodiments, the EBSR includes at least one of:
(1) A field including one BS index (for example, “Buffer Size (BS)” field as shown in FIG. 6 or FIG. 7). This field is denoted as “the first field” for simplicity. A buffer size of the first field indicated by the one BS index represents a UL data volume for transmission in one or more LCGs or in one or more LCHs. In some embodiments, the one BS index is included in a BS table. Each BS index in the two or more BS indexes is included in one BS table or in two or more BS tables. For example, each of the one BS table and the two or more BS tables may include one-to-one mapping relation between multiple BS indexes and multiple buffer sizes.
(2) A field including two or more BS indexes (for example, “Partial Buffer Size” field as shown in any of FIGS. 4-7). This field is denoted as “the second field” for simplicity. A sum of buffer sizes indicated by the two or more BS indexes of the second field represents the UL data volume for transmission in the one or more LCGs or in the one or more LCHs.
(3) A field indicating a presence of the second field for the one or more LCGs or for the one or more LCHs (for example, “Index Combination i (ICᵢ)” field as shown in FIG. 7). This field is denoted as “the third field” for simplicity.

In some embodiments, the UE may select at least one of the first field and the second field to be used in the EBSR for an LCG or an LCH, and transmit an indication for indicating that the at least one of the first field and the second field is used in the EBSR for the LCG or the LCH to the network. In an embodiment, the UE may determine whether a difference between the UL data volume and the buffer size indicated by the one BS index is greater than or equal to a threshold. The UE may select the second field to be used in the EBSR, in response to determining that the difference is greater than or equal to the threshold. The UE may select the first field to be used in the EBSR, in response to determining that the difference is less than the threshold.

In some embodiments, the UE may receive, from the network, a configuration which indicates at least one of:
(4) a set of LCGs or a set of LCHs which can use the first field in the EBSR; or (5) another set of LCGs or another set of LCHs which can use the second field in the EBSR.

In some embodiments, the UE may receive a configuration related to one or more BS tables for an LCG or an LCH from the network. A BS index included in the EBSR may be selected from the one or more BS tables. For example, each of the one or more BS tables may include one-to-one mapping relation between multiple BS indexes and multiple buffer sizes.

In an embodiment, the UE may receive, from the network, at least one of:
(1) A deactivation command to stop using a BS table within the one or more BS tables for the LCG or the LCH. In some embodiments, the UE may suspend the function of the EBSR (for the LCG or the LCH using the BS table indicated by the command) immediately or after a period of time duration upon reception of the deactivation command. In an embodiment, the UE may transmit a confirmation of the deactivation command to the network.
(2) An activation command to use the BS table for the LCG or the LCH. In some embodiments, the UE may resume the function of the EBSR (for the LCG or the LCH using the BS table indicated by the command) immediately or after a period of time duration upon reception of the activation command. In an embodiment, the UE may transmit a confirmation of the activation command. Specific examples are described in embodiments of FIG. 8.

In some embodiments, at least one of the deactivation command or the activation command is received in a MAC CE or DCI. In some embodiments, the deactivation command and the activation command may be received in the same message.

In some embodiments, at least one of the deactivation command or the activation command includes one of:
(1) at least one of: a table information of the BS table, or an ID of the LCG;
(2) at least one of: the table information of the BS table, or an ID of the LCH; and
(3) a bitmap corresponding to the one or more BS tables, to indicate that the BS table is deactivated or activated for the LCG or the LCH. Specific examples are described in embodiments of FIG. 9.

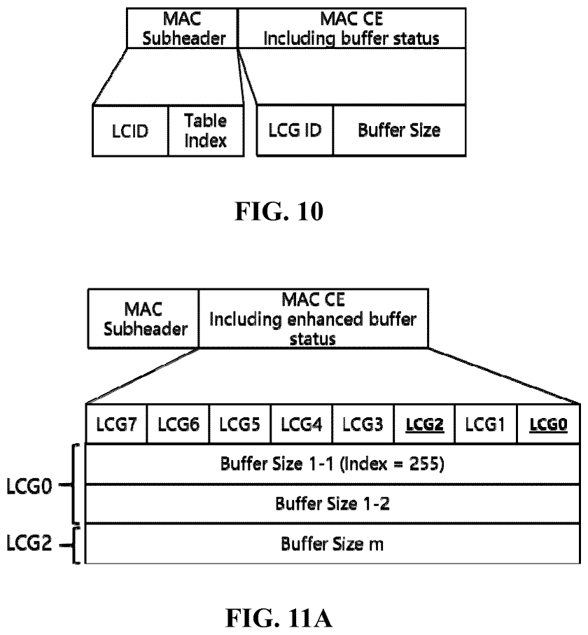

In some embodiments, a MAC sub-PDU including the EBSR indicates table information of a BS table used for the EBSR. For example, the BS table may include one-to-one mapping relation between multiple BS indexes and multiple buffer sizes. The table information of the BS table may be indicated by at least one of:
(1) an LCID field in a subheader of the MAC sub-PDU; or
(2) a field which is different from the LCID field in the subheader of the MAC sub-PDU. Specific examples are described in embodiments of FIG. 10.

In some embodiments, the UE may receive, from the network, a configuration which is related to mapping relation between a value in the LCID field and the table information of the BS table. In an embodiment, mapping relation between a value in the LCID field and the table information of the BS table may be predefined by a specification or protocol.

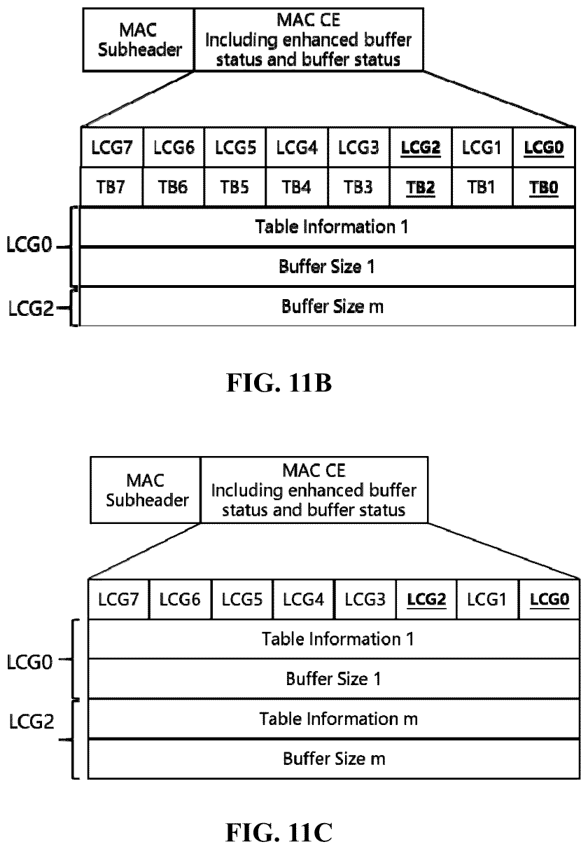

In some embodiments, the UE may set a value of a field in the EBSR (denoted as “the fourth field” for simplicity) as a specific value, and may set a value of another field in the EBSR (e.g., following or before the fourth field) to indicate a UL data volume. For instance, the value of the fourth field may be included in a BS table for an LCG or an LCH. Specific examples are described in embodiments of FIG. 11A.

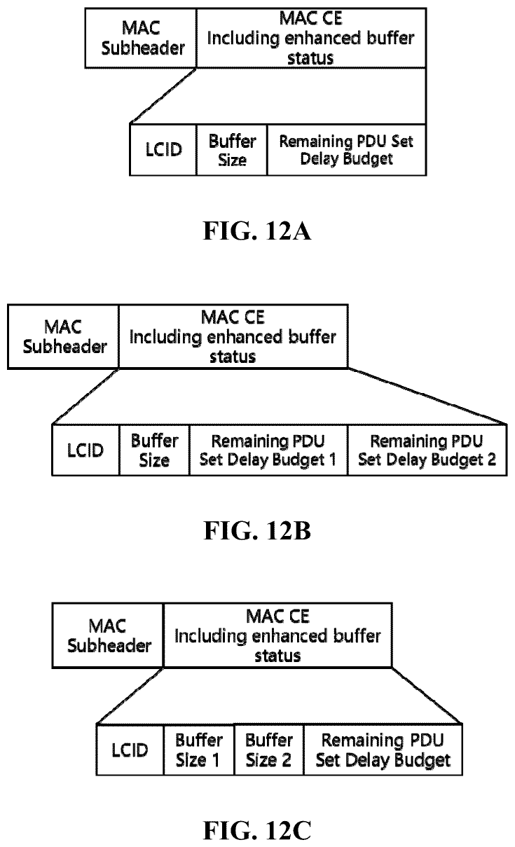

In some embodiments, the EBSR includes at least one of:
(1) one or more delay information (DI) fields including delay information associated with one or more protocol data unit (PDU) sets; or
(2) one or more BS fields including one or more BS indexes associated with the delay information. Specific examples are described in embodiments of FIGS. 12A-12C. In an embodiment, one or more buffer sizes indicated by the one or more BS indexes represent:
1) a total amount of data available for transmission in the one or more PDU sets corresponding to the delay information; or
2) a total amount of data available for transmission in an LCH; or
3) a total amount of data available for transmission across all LCHs of an LCG.

In some embodiments, the delay information includes at least one of:
(1) A remaining PDU set delay budget. In an embodiment, the remaining PDU set delay budget corresponds to one PDU set with a minimum delay budget within the one or more PDU sets.
(2) A PDU set buffer delay. In an embodiment, the PDU set buffer delay corresponds to one PDU set with a maximum buffer delay within the one or more PDU sets.
(3) A PDU set delay budget offset.
(4) Timing when receiving a PDU within the one or more PDU sets from an upper layer of the UE. In an embodiment, the timing corresponds to one PDU set with earliest arriving timing within the one or more PDU sets.

In some embodiments, the delay information includes delay information associated with a first arrival PDU or a last arrival PDU of one PDU set within the one or more PDU sets.

In some embodiments, the delay information includes delay information corresponding to one PDU set with a highest priority logical channel within the one or more PDU sets. For instance, the highest priority logical channel is allowed to report such delay information in an LCG or in a MAC entity of the UE or in the UE. In some embodiments, the delay information includes at least one of:
(1) delay information corresponding to one PDU set within the one or more PDU sets in an LCH with or without data available for transmission; or
(2) delay information corresponding to one PDU set within the one or more PDU sets in an LCG with or without data available for transmission.

In some embodiments, the one or more DI fields and the one or more BS fields for an LCH or an LCG are interleaved in the EBSR to form one or more pairs of DI fields and BS fields. Specific examples are described in embodiments of FIG. 14.

In some embodiments, the one or more DI fields within the one or more pairs for an LCH or an LCG are ordered:
(1) in an ascending order based on a remaining PDU set delay budget;
(2) in a decreasing order based on a PDU set buffer delay;
(3) in an ascending order based on arriving timing at an AS layer of the UE of a first arrival PDU; or
(4) in an ascending order based on arriving timing at the AS layer of the UE of a last arrival PDU.

In some embodiments, in response to that allocated UL resources is not sufficient to accommodate the one or more pairs in the EBSR for one or more LCHs or one or more LCGs, the UE may:
(1) prioritize the one or more pairs in a decreasing order of priorities of the one or more LCHs;
(2) prioritize the one or more pairs in a decreasing order of a highest priority logical channel in each of the one or more LCGs; or
(3) in case that the one or more pairs have an equal logical channel priority, prioritize the one or more pairs in an increasing order or a decreasing order of the value of the delay information. For instance, the allocated UL resources include a part of the prioritized one or more pairs.

FIG. 3 illustrates a further exemplary flowchart for receiving an EBSR in accordance with some embodiments of the subject application. The exemplary method 300 in FIG. 3 may be performed by a network node, for example, a base station (e.g., BS 101 as shown in FIG. 1A). Although described with respect to a network node, it should be understood that other devices may be configured to perform a method similar to that of FIG. 3.In the exemplary method 300 in FIG. 3, in operation 301, a network node transmits a configuration for enabling a function of an EBSR to a UE. In operation 302, the network node receives the EBSR from the UE.

In some embodiments, the EBSR includes at least one of:
(1) A field (denoted as “the first field” for simplicity) including one BS index. A buffer size of the first field indicated by the one BS index represents a UL data volume for transmission in one or more LCGs or in one or more LCHs. In some embodiments, the one BS index is included in a BS table. Each BS index in the two or more BS indexes is included in one BS table or in two or more BS tables.
(2) A field (denoted as “the second field” for simplicity) including two or more BS indexes. A sum of buffer sizes indicated by the two or more BS indexes of the second field represents the UL data volume for transmission in the one or more LCGs or in the one or more LCHs.
(3) A field (denoted as “the third field” for simplicity) indicating a presence of the second field for the one or more LCGs or for the one or more LCHs.

In some embodiments, the network node may transmit, to the UE, a configuration which indicates at least one of:
(1) a set of LCGs or a set of LCHs which can use the first field in the EBSR; or
(2) another set of LCGs or another set of LCHs which can use the second field in the EBSR.

In some embodiments, the network node may transmit a configuration related to one or more BS tables for an LCG or an LCH to the UE. For instance, a BS index included in the EBSR is selected from the one or more BS tables.

In some embodiments, the network node may transmit, to the UE, at least one of:
(1) a deactivation command to stop using a BS table within the one or more BS tables for the LCG or the LCH. In an embodiment, the network node may receive a confirmation of the deactivation command from the UE.
(2) an activation command to use the BS table for the LCG or the LCH. In an embodiment, the network node may receive a confirmation of the activation command from the UE.

In some embodiments, at least one of the deactivation command or the activation command is transmitted in a MAC CE or DCI.

In some embodiments, at least one of the deactivation command or the activation command includes one of:
(1) at least one of: table information of the BS table, or LCG information (e.g., an ID of the LCG_;
(2) at least one of: the table information of the BS table, or LCH information (e.g., an ID of the LCH); and
(3) a bitmap corresponding to the one or more BS tables, to indicate that the BS table is deactivated or activated for an LCG or an LCH.

It should be appreciated by persons skilled in the art that the sequence of the operations in the exemplary flowcharts 200 and 300 may be changed, and some of the operations in the exemplary flowcharts 200 and 300 may be eliminated or modified, without departing from the spirit and scope of the disclosure. Details described in all other embodiments of the subject application, e.g., in the embodiments of FIGS. 2 and 3 are applicable for this exemplary flowchart. Moreover, details described in this exemplary flowchart are applicable for all the embodiments of FIGS. 1A, 1B, and 4-20.

FIGS. 4-18 illustrate exemplary MAC PDUs related to an EBSR in accordance with some embodiments of the subject application.

In some embodiments of the subject application, a buffer size for an LCG or an LCH using a buffer size index combination is reported to a network. In particular, in order to reduce a quantization error between the actual buffer size and reported buffer size base on the legacy BSR format, a UE may transmit an EBSR including a BS index combination to indicate the UL data volume for transmission in an LCG or in an LCH by a sum of the buffer sizes corresponding to the two identifiers in order to assist the network to accurately determine the UL available data for transmission at the UE.

In an embodiment, a UE transmits an EBSR format indicating a BS index combination and one LCG to the network according to configuration by the network. This embodiment may include operations (A)-(C) as follows.

In operations (A), a network transmits a configuration about using an EBSR format to a UE, e.g., by RRC message or MAC CE if the UE reports its capability of supporting the EBSR. The configuration may include at one of:
(1) An indicator which is used to enable the UE to use the EBSR format. For example, a true value presents that the EBSR format including a BS index combination is enabled to be used for an LCG or an LCH of the UE or for the UE, while a false value presents that the EBSR format including a BS index combination is disabled to be used for an LCG or an LCH of the UE or for the UE.
(2) A quantization threshold which is used to judge whether to use the BS index combination.

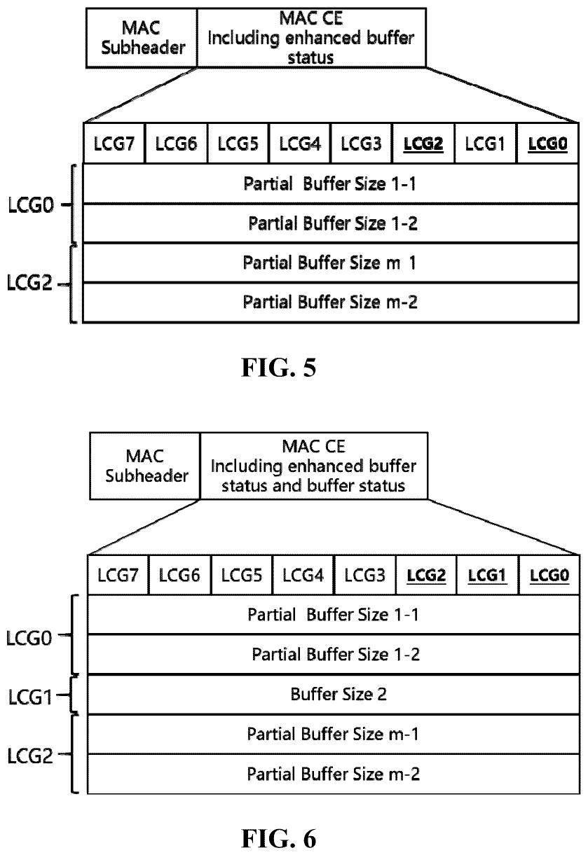

In operations (B), the UE determines a BS index combination including at least two BS indexes in a BS table as an index combination to indicate the UL data volume for transmission in an LCG by a sum of the buffer sizes corresponding to the two identifiers. Specific examples are described in embodiments of FIGS. 4 and 5. In operations (C), the UE transmits the EBSR to the network.

For instance, FIGS. 4 and 5 illustrate exemplary MAC PDUs related to an EBSR including a BS index combination in accordance with some embodiments of the subject application. FIG. 4 shows a short EBSR format or a short truncated EBSR format indicating 2 BS indexes for an LCG. FIG. 5 shows a long EBSR format or a long truncated EBSR format indicating 2 BS indexes for an LCG. A new LCID in a MAC subheader may be allocated to identify a MAC CE related to an EBSR in FIG. 4 or FIG. 5.

As shown in FIGS. 4 and 5, the MAC CE including enhanced buffer status for an LCG or all LCGs includes at least one of following fields:
(1) LCG ID (the Logical Channel Group ID): this field identifies a group of logical channel(s) whose buffer status is being reported. The length of the LCG ID field may be 3 bits.
(2) LCGᵢ: For the long BSR or EBSR format and Pre-emptive BSR or EBSR format, this field indicates the presence of the Buffer Size field and/or the Partial Size field for the LCG i. The LCGᵢ field set to 1 indicates that the Buffer Size field and/or the Partial Buffer Size field for the LCG i is reported. The LCGᵢ field set to 0 indicates that the Buffer Size field and/or the Partial Buffer Size field for the LCG i is not reported. For the long truncated BSR format, this field indicates whether LCG i has data available. The LCGᵢ field set to 1 indicates that the LCG i has data available. The LCGi field set to 0 indicates that the LCG i does not have data available.
(3) Partial Buffer Size: this field identifies the partial amount of data available according to the data volume calculation procedure in 3GPP TS38.322 [3] and TS38.323 [4] across all LCHs of an LCG if configured to use a BS index combination after the MAC PDU has been built (i.e., after the logical channel prioritization procedure, which may result the value of the Partial Buffer Size field to be zero).
   1) A sum of the Partial Buffer Size fields identifies the total amount of data available according to the data volume calculation procedure in TS38.322 [3] and TS38.323 [4] across all logical channels of an LCG if configured to use the BS index combination after the MAC PDU has been built. The amount of data is indicated in number of bytes. The size of RLC headers and MAC subheaders are not considered in the buffer size computation.
   2) The length of the Partial Buffer Size field for the short EBSR format and the short truncated EBSR format is 5 bits. The length of this field for the long EBSR format and the long truncated EBSR format is 8 bits. The values for the 5-bit and 8-bit Partial Buffer Size fields may be shown in Tables 6.1.3.1-1 and 6.1.3.1-2 in 3GPP TS38.321, respectively.
   3) For the long BSR format and the long truncated BSR format, the Partial Buffer Size fields are included in an ascending order based on the LCGᵢ. For the long truncated BSR format, the number of Partial Buffer Size fields included may be maximized, while not exceeding a total number of padding bits.

As shown in FIG. 4, a BS index combination includes Partial Buffer Size 1 and Partial Buffer Size 2 for an LCG. A sum of the buffer sizes corresponding to Partial Buffer Size 1 and Partial Buffer Size 2 indicate the UL data volume for transmission in the LCG. As shown in FIG. 5, a BS index combination includes two Partial Buffer Sizes for an LCG, e.g., “Partial Buffer Size 1-1” and “Partial Buffer Size 1-2” for LCG0, and “Partial Buffer Size m-1” and “Partial Buffer Size m-2” for LCG2.

For instance, in a specific example, when an EBSR is triggered for LCH in the LCG0, both the UL data volume of LCG0 calculated based on TS38.322 and TS38.323 is 46261 bytes, “index=135” which represents a buffer size value less than or equal to 48676 needs to be allocated as the Buffer Size. 48676-46261=2415.

That is, a quantization error between the actual buffer size 46261 and the reported buffer size 48676 is 2415 bytes. Taking the embodiments of FIG. 5 as an example (FIG. 4 is in the same manner), “index=134” and “index=85” may be used for “Partial Buffer Size 1-1” and “Partial Buffer Size 1-2” of LCG0, respectively. In particular, as shown in Table 6.1.3.1-2 in 3GPP TS38.321, “index=134” represents a buffer size value of 45709, and “index=64” represents a buffer size value of 560. 45709+560=46269. 46269−46261=8. As can be seen, using a BS index combination for LCGO may allocate the buffer size value of 46269. A quantization error between the actual buffer size 46261 and the reported buffer size 46269 is only 8 bytes, which is apparently reduce a quantization error between the actual buffer size and the reported buffer size, i.e., reduced from 2415 bytes to 8 bytes.

The embodiments of a BS index combination in FIGS. 4 and 5 may assist the network to accurately determine the UL available data for transmission at the UE and reduce a quantization error between the actual buffer size and the reported buffer size.

In a further embodiment, a UE uses legacy buffer status for some LCGs or some LCHs and uses enhanced buffer status for some LCGs or some LCHs according to a configuration by a network. This embodiment may include operations (a) and (b) as follows.

In operations (a), a network can configure a UE to use an EBSR per a part of LCGs or LCHs to the UE. For example, the indicator value of LCGO and LCG2 may be set as TURE. For example, the indicator value of LCHO and LCH2 may be set as TURE.

In operations (b), the UE determines a BS index combination including at least two BS indexes in a BS table as an index combination to indicate the UL data volume for transmission in an LCG or an LCH allowed to use the EBSR by the network by a sum of the buffer sizes corresponding to these two identifiers. A specific example is described in embodiments of FIG. 6.

FIG. 6 illustrates an exemplary MAC PDU related to an EBSR including a BS index combination in accordance with some embodiments of the subject application. FIG. 6 shows an EBSR format for LCG0 and LCG 2 and a BSR format for LCG 1. A new LCID in the MAC subheader may be allocated to identify a MAC CE related to an EBSR in FIG. 6. The MAC CE in FIG. 6 includes enhanced buffer status and legacy buffer status, and includes similar fields to those in FIGS. 4 and 5, i.e., the LCG ID field, the LCGi field, and the Partial Buffer Size field. In addition, the MAC CE in FIG. 6 further includes:
(1) Buffer Size (BS): this field identifies a total amount of data available according to the data volume calculation procedure in 3GPP TS38.322 [3] and TS38.323 [4] across all LCHs of an LCG if not configured to use the BS index combination after the MAC PDU has been built (i.e., after the logical channel prioritization procedure, which may result the value of the BS field to be zero). The amount of data is indicated in number of bytes. The size of the RLC headers and MAC subheaders are not considered in the buffer size computation. The length of this field for the short BSR format and the short truncated BSR format is 5 bits. The length of this field for the long BSR format and the long truncated BSR format is 8 bits. The values for the 5-bit and 8-bit BS fields are shown in Tables 6.1.3.1-1 and 6.1.3.1-2 in 3GPP TS38.321, respectively. For the long BSR format and the long truncated BSR format, the BS fields are included in an ascending order based on the LCGi. For the long truncated BSR format, the number of BS fields included is maximized, while not exceeding the number of padding bits.

For instance, in a specific example, when an EBSR is triggered for LCHs in the LCG0 and LCG2, a UL data volume of LCG0 and LCG2 may be calculated based on TS38.322 and T38.323 is 46261 bytes, i.e., a sum of “Partial Buffer Size 1-1” and “Partial Buffer Size 1-2” for LCG0 and a sum of “Partial Buffer Size m-1” and “Partial Buffer Size m-2” for LCG2. Similar to FIGS. 4 and 5, a BS index combination in FIG. 6 for LCG0 and LCG2 may reduce a quantization error between the actual buffer size and the reported buffer size. BSR is triggered for LCH in LCG1. “Partial Buffer Size 2” for LCG1 may be calculated based on in Table 6.1.3.1-2 in 3GPP TS38.321. For example, “index=134” which represents a buffer size value of 45709 may be used for “Buffer Size 2” of LCG1.

In another embodiment, a UE selects a BS index in one BS table and a BS index in another BS table as an index combination, to indicate the UL data volume in one LCG or an LCH by a sum of the buffer sizes corresponding to the two identifiers. For example, in the embodiments of FIG. 4, Partial Buffer Size 1 and Partial Buffer Size 2 for an LCG may refer to two different BS tables, e.g., Tables 6.1.3.1-1 and 6.1.3.1-2 in 3GPP TS38.321. Similarly, in the embodiments of FIGS. 5 and 6, “Partial Buffer Size 1-1” and “Partial Buffer Size 1-2” for LCG0 may refer to two different BS tables, and “Partial Buffer Size m-1” and “Partial Buffer Size m-2” for LCG2 may refer to two different BS tables. Thus, a sum of buffer sizes corresponding to indices of two Partial buffer sizes may be calculated based on these two different BS tables.

In yet another embodiment, a UE may dynamically select enhanced buffer status and buffer status for an LCG or an LCH, even if the LCG or the LCH is allowed to use an EBSR by an RRC message. The UE may indicate which is selected for the LCG or the LCH in the EBSR. A specific example is described in embodiments of FIG. 7. In this embodiment, a UE may determine whether to use an EBSR or a BSR for an LCG or an LCH based on one of:
(1) it is up to the UE's implementation; or
(2) it is pre-defined in the protocol (or specification) or configured by RRC signalling, if the legacy BSR format introduces the quantization error higher than or equal to a quantization threshold.

For example, the quantization threshold is 200 bytes. When an EBSR is triggered for an LCH in LCG0 and LCG1, the UL data volume of LCG0 calculated is 46261 bytes, and the UL data volume of LCG1 calculated is 45609 bytes. According to the quantization threshold, a quantization error between 46261 bytes and a nearest buffer size value of 45709 represented by BS index 134 is greater than the quantization threshold (i.e., 200 bytes), and thus the EBSR is selected for the LCG0. A quantization error between 45609 bytes and a nearest buffer size value of 45709 represented by BS index 134 is less than the quantization threshold, and thus the BSR is selected for LCG1.

FIG. 7 illustrates a further exemplary MAC PDU related to an EBSR including a BS index combination in accordance with some embodiments of the subject application. FIG. 7 shows an EBSR format for LCG0 and a BSR format for LCG 1. A new LCID in the MAC subheader may be allocated to identify a MAC CE related to an EBSR in FIG. 7. The MAC CE in FIG. 7 includes enhanced buffer status and buffer status, and includes similar fields to those in FIG. 6, i.e., the LCG ID field, the LCGᵢ field, the Partial Buffer Size field, and the BS field. In addition, the MAC CE in FIG. 7 further includes:
(1) Index Combination i (ICᵢ): For the long EBSR format and pre-emptive EBSR format, this field indicates the presence of the Partial Buffer Size field for the LCG i. For example, the ICᵢ field set to 1 indicates that the Partial Buffer Size field for the LCG i is reported. The ICᵢ field set to 0 indicates that the BS field for the LCG i is used.

For instance, as shown in FIG. 7, in a specific example, ICO field set to 1 indicates that the Partial Buffer Size field for LCG0 is used. ICI field set to 0 indicates that the Buffer Size field for LCG1 is used. A sum of “Partial Buffer Size 1-1” and “Partial Buffer Size 1-2” for LCG0 may be calculated as a UL data volume of LCG0. “Buffer Size 2” for LCG1 may be calculated as a UL data volume of LCG1.

In an additional embodiment, a UE may transmit an EBSR format indicating a BS index combination and one LCH to the network. The embodiments of FIGS. 4-7 also apply to this embodiment except that the LCG is replaced by the LCH. For example, “LCG ID” field in FIG. 4 is replaced by “LCID” field, to identify the logical channel whose buffer status is being reported. The “LCGᵢ” field in FIGS. 5-7 is replaced by “LCHᵢ” field, to indicate the presence of the BS field and/or the Partial Size field for the LCH i. This Partial Buffer Size field identifies the partial amount of data available of an LCH. Accordingly, “ICᵢ” field in FIG. 7 indicates the presence of the Partial BS field for the LCH i.

In some embodiments of the subject application, a BS for an LCG or an LCH according to a BS table configured by RRC signalling is reported to a network. In particular, in order to reduce a quantization error between the actual buffer size and reported buffer size base on the legacy BSR format, a UE may transmit an BSR including a BS index selected from a table configured for the UE (e.g., for an LCG or an LCH) by the network, in order to assist the network to accurately determine the UL available data for transmission at the UE.

In an embodiment, a UE transmits a BSR including a BS index selected from a BS table for an LCG configured by a network. This embodiment may include operations (1)-(3) as follows.

In operations (1), a network configures a BS table identified by a BS table index used for the BSR for an LCG. For example, one BS table corresponding to a BS table index can be designed according to one kind of traffic characteristic, which includes a bit rate, a frame rate, and/or, a group of pictures (GOP) size. Therefore, more new BS tables can be introduced in TS 38.321 like Buffer size Table 6.1.3.1-2 or Buffer size Table 6.1.3.1-1 in 3GPP TS38.321. The network receives at least one of the traffic characteristics from the UE or a core network and configures a BS Table index for BSR of the LCG0 according to characteristics of the traffic carrying on the LCH in the LCG.

In operations (2), when BSR is triggered for LCH in the LCG, UE select the BS index in the configured table for the LCG.

In operations (3), the network reconfigures a BS table identified by a BS table index used for the BSR for an LCG. For example, if the characteristics of traffic changes, e.g., frame rate changes from 60 fps to 30 fps, or rate from 10 Mps to 20 Mps, the network can transmit an RRC message indicating the UE to release the configured BS table for the LCG. After receiving the confirm message, the network configure a BS table for the LCG to the UE. This handling can synchronize the BS table between the network and the UE for changing the BS table, but it brings the BSR interruption for some time caused by the RRC procedure.

In a further embodiment, in order to decrease the reconfigure delay for changing the BS table, a network may configure a list of BS table for one LCG to a UE. When the UE is enabled to use the first BS table for the LCG, e.g., according to the configuration by RRC message, and if BS table change is needed, the network may send MAC CE or downlink control information (DCI) in PDCCH to change the BS table index for one LCG. Specific examples are described in embodiments of FIGS. 8 and 9.

FIG. 8 illustrates an exemplary MAC PDU for changing a BS table for an LCG or an LCH in accordance with some embodiments of the subject application. As shown in FIG. 8, the MAC CE including BS Table includes at least one of following fields:
(1) LCG ID or LCID: this field identifies a group of logical channel(s) or an LCH to which a BS table is related. The length of the LCG ID or LCID field may be 3 bits.
(2) Table Index: this field identifies an index of a BS table.

Some embodiments of FIG. 8 refer to a 2-step changing BS table procedure. In some embodiments of FIG. 8, a network node (e.g., a gNB) transmits a MAC CE of a deactivation command to stop using a BS table for an LCG. The deactivation command may include a BS table's index (i.e., the Table Index field) and/or LCG ID, as shown in FIG. 8. After the UE receives the deactivation command, the UE may send a confirmation to the gNB. For example, an LCID field with a new LCID in the MAC subheader or another field in MAC CE may be used to indicate the deactivation of the BS table indicated by the BS table index field for the LCG.

In some embodiments of FIG. 8, after the UE receives the command, the UE may send confirmation of the deactivation command to the gNB and may suspend the BSR procedure (for the LCG or the LCH using the BS table indicated by the command) upon reception of the command immediate or after some time. For example, the confirmation may include LCG ID. The confirmation may be HARQ-ACK.

In some embodiments of FIG. 8, after the gNB receives the confirmation of the deactivation command, the gNB may send an activation command MAC CE to the UE. The activation command may include another BS table index and LCG ID, as shown in FIG. 8. For example, an LCID field with a new LCID in the MAC sub header or another field in MAC CE may be used to indicate the activate the BS table indicated by the BS table index field for the LCG. After the UE receives the activation command, the UE may send a confirmation to the gNB and may resume the BSR procedure (for the LCG or the LCH using the BS table indicated by the command) upon reception of the activation command immediately or after some time duration.

Some embodiments of FIG. 8 refer to a 1-step deactivation and activation BS table procedure. In some embodiments of FIG. 8, a deactivation command and an activation command may be received by a UE in the same message. In some embodiments of FIG. 8, a network node (e.g., a gNB) transmits a MAC CE of a modify command to stop using a BS table (e.g., the first BS table) and start using another BS table (e.g., the second BS table) for an LCG or an LCH. The Table Index field in the MAC CE of FIG. 8 includes an index of the second BS table. In some embodiments of FIG. 8, after the UE receives the modify command, the UE may suspend the BSR procedure (for the LCG or the LCH using the BS table indicated by the command) for the first BS table upon reception of the modify command immediately or after some time duration. The UE may resume the BSR procedure (for the LCG or the LCH using the BS table indicated by the command) based on the second BS table upon reception of the modify command immediately or after some time duration.

FIG. 9 illustrates an exemplary MAC PDU for deactivation and activation of a BS table for an LCG or an LCH in accordance with some embodiments of the subject application. As shown in FIG. 9, the MAC CE including BS Table includes at least one of following fields:
(1) LCG ID or LCID: this field identifies a group of logical channel(s) or an LCH to which a BS table is related. The length of the LCG ID or LCID field may be 3 bits.
(2) Tᵢ: this field indicates the activation or deactivation status of the BS table i, and “i” is the ascending order of the BS table ID among the BS tables allowed for BSR of the LCG or LCH. The Tᵢ field is set to 1 to indicate that the status of Table i shall be activated. The Tᵢ field is set to 0 to indicate that the status of Table i shall be deactivated.

The embodiments of FIG. 9 also refer to a 1-step deactivation and activation BS table procedure. In some embodiments of FIG. 9, a network node (e.g., a gNB) transmits a MAC CE of a modify command to stop using a BS table (for example, the first BS table, e.g., table 0) and start using another BS table (for example, the second BS table, e.g., table 1) for an LCG or an LCH. The Tᵢ field in the MAC CE of FIG. 9 includes a bitmap to indicate which BS table is activated for an LCG or an LCH. For example, T2 is set to 0, to represent that table 2 is deactivated for the LCG or the LCH. T1 is set to 1, to represent that table 1 is activated for the LCG or the LCH. T0 is set to 0, to represent that table 0 is deactivated for the LCG or the LCH. That is, the bitmap is 010, to indicate that table 1 is activated for the LCG or the LCH.

In some embodiments of FIG. 9, after the UE receives the modify command with the bitmap, the UE may suspend the BSR procedure (for the LCG or the LCH using the BS table indicated by the command) for the first BS table (e.g., table 0) upon reception of the modify command immediately or after some time duration. The UE may resume the BSR procedure based on the second BS table (e.g., table 1) (for the LCG or the LCH using the BS table indicated by the command) upon reception of the modify command immediately or after some time duration.

In some embodiments of the subject application, a UE uses a pre-defined new LCID in a MAC subheader of a BSR to indicate that a new BS table is used for the BSR. This nature of this embodiment is one new table is used for all the BSR.

Some embodiments introduce one or more new BS tables, e.g., with 8-bit Buffer Size or 5-bit Buffer Size. A new LCID from the reserved LCID values may be allocated to identify a new BS table. The new BS table may be designed taking account of one kind of traffic characteristic, which includes at least one of a bit rate, a frame rate, and/or, a GOP size.

In some embodiments, the mapping between an LCID and a new BS table is configured by a protocol, e.g., in a table. For example, the new BS table may be like the Buffer size levels (in bytes) for 5-bit Buffer Size field or Buffer size levels (in bytes) for 8-bit Buffer Size field as defined in Tables 6.1.3.1-1 and 6.1.3.1-2 in 3GPP TS38.321. For instance, a LCID from the reserved codepoint or index values “35˜44” may be allocated to identify a new BS table. In a specific example, codepoint or index value “36” may be allocated to identify a new BS table, e.g., Enhanced BSR for BS table A; in a further specific example, codepoint or index value “37” may be allocated to identify a new BS table, e.g., Enhanced BSR for BS table B; or the like.

In an embodiment, when a UE selects BS table A or BS table B for the BSR, the UE may include the mapped LCID in the BSR MAC CE corresponding MAC subheader. The BSR MAC format may be the same as the legacy BSR MAC format.

In some further embodiments of the subject application, the mapping between an LCID and a BS table is configured by a network, e.g., in an RRC message or a MAC CE.

In some other embodiments of the subject application, a UE uses another field in the MAC subheader, instead of the LCID field in the MAC subheader, to indicate a specific BS table. A BS index in a BSR may be selected from the specific BS table. A specific example is described in embodiments of FIG. 10.

FIG. 10 illustrates an exemplary MAC PDU related to a BSR including in accordance with some embodiments of the subject application. The MAC CE in FIG. 10 includes buffer status. The MAC CE in FIG. 10 includes the LCID field, the LCG ID field, and the BS field, which are similar to those in any of FIGS. 6-8. In addition, the MAC CE in FIG. 10 further includes the Table Index field in the MAC subheader to identify an index of a BS table. A new LCID in the MAC subheader may be allocated to the Table index in MAC subheader in FIG. 10.

In some other embodiments of the subject application, a UE uses the BS Index with a specific value (e.g., 255) to indicate another field including the actual BS index in a new BS table for one LCG. A specific example is described in embodiments of FIG. 11A.

FIG. 11A illustrates an exemplary MAC PDU related to an EBSR in accordance with some embodiments of the subject application. For example, the new BS table with 8-bit BS may be defined. FIG. 11A shows an example of an enhanced BSR MAC CE indicating the BS in a new BS table. A new LCID in the MAC sub header may be allocated to identify the EBSR MAC CE in FIG. 11A. The MAC CE in FIG. 11A includes “Buffer size” field, e.g., “Buffer Size 1-1”, “Buffer Size 1-2”, and “Buffer Size m” as shown in FIG. 11A. For instance, if the value of the first field (e.g., 8-bit buffer size) corresponding to the LCG i is set to a specific value (e.g., 255), the buffer size corresponding to LCG i is present at the second field (e.g., 8-bit buffer size) which value is shown in the new BS table. In some embodiments, the MAC CE as shown in FIG. 11A may further include an LCG ID, “Buffer Size 11”, and “Buffer Size 1-2” to indicate the data volume available for transmission for one LCG.

As shown in FIG. 11A, in a specific embodiment, “Buffer Size 1-1” and “Buffer Size 1-2” are used together to indicate the UL data volume for transmission in LCG0. The value of the LCGi field indicates the presence of the Buffer Size 1-1 field for the LCG i. For example, in “Buffer Size 1-1” for LCG0, BS index is set to a specific value (e.g., 255), to indicate another field, i.e., “Buffer Size 1-2”, including the actual BS index in a new BS table for LCG0. For example, if BS index of “Buffer Size 1-2” is set to 85 shown in the new table. “Buffer Size m” is used to indicate the UL data volume for transmission in LCG2, which is the same as the BS field in FIGS. 6 and 7. For example, the actual BS of LCG2 is indicated by BS index=134 in the old table, e.g., Table 6.1.3.1-1 or Table 6.1.3.1-2 in 3GPP TS38.321.

In some other embodiment of the subject application, a UE uses the BS Index with a specific value (e.g., 255) to indicate another field including the actual BS index in a new BS table for one LCH. For example, “LCG ID” field is replaced by “LCID” field, to identify the logical channel whose buffer status is being reported. The “LCGᵢ” field in FIGS. 11 is replaced by “LCHᵢ” field, to indicate the presence of the Buffer Size 1-1 field for the LCH i.

In some other embodiments, a UE may include a field in the EBSR (denoted as “the fifth field” for simplicity) indicating information of a BS table, and may set a value of another field in the EBSR (e.g., following or before the fourth field) to indicate a UL data volume. The UE may optionally include a field in the EBSR (denoted as “the sixth field” for simplicity), and the value of this field indicates the fifth field (i.e., the table information field) of one LCG or one LCH is present or not in the EBSR. For instance, the value of the sixth field may be included in a BS table for an LCG or an LCH. If the EBSR includes enhanced buffer status and buffer status for different LCGs or LCHs, the table information field and the BS field considered as a whole and the legacy BS field are included in an ascending order of the LCG i. If the EBSR only includes enhanced buffer status for all LCGs or LCHs, the table information field and the BS field are considered as a whole, with an ascending order of the LCG i. Specific examples are described in embodiments of FIG. 11B or FIG. 11C.

FIGS. 11B and 11C illustrate exemplary MAC PDUs related to an EBSR in accordance with some embodiments of the subject application. A new LCID in the MAC subheader may be allocated to identify a MAC CE related to an EBSR in FIG. 11B or FIG. 11C. The MAC CEs in FIGS. 11B and 11C include enhanced buffer status and buffer status, and include the LCGᵢ field and the BS field (e.g., Buffer Size 1 and Buffer Size m) which are similar to those in FIG. 11A. The MAC CEs in FIGS. 11B and 11C include:
(1) Table Information: this field indicates an index of a BS table used for the LCG i.

In addition, the MAC CE shown in FIG. 11B further includes at least one of following fields:
(1) TBᵢ: this field corresponds to the LCGᵢ field. The TBᵢ field is set to 1 to indicate that the table information field of the LCG i is present. The TBi field is set to 0 to indicate that the table information field of LCG i is not present, and the buffer size index of the LCG i is in the legacy table, e.g., 8 bits BS index table as defined in 3GPP TS38.321.

For example, for LCG0 as shown in FIG. 11B, TB0 corresponding to LCG0 is set to 1, to indicate that the table information field of LCG0 is present. “Table Information 1” indicates an index of a specific BS table used for LCG0, and “Buffer Size 1” indicates the actual BS index in the specific BS table. Thus, UL data volume for transmission in LCG0 may be determined based on both “Table Information 1” and “Buffer Size 1”. TB2 corresponding to LCG2 is set to 0, to indicate that the table information field of LCG0 is not present. Thus, “Buffer Size m” is used to indicate the UL data volume for transmission in LCG2, which is the same as the BS field in FIG. 11A.

For example, for LCG0 as shown in FIG. 11C, “Table Information 1” indicates an index of a specific BS table used for LCG0, and “Buffer Size 1” indicates the actual BS index in the specific BS table. Thus, UL data volume for transmission in LCG0 may be determined based on both “Table Information 1” and “Buffer Size 1”. “Table Information m” indicates an index of another specific BS table used for LCG2, and “Buffer Size m” indicates the actual BS index in the another specific BS table (which may be the same as or different from the specific BS table for LCG0). Thus, UL data volume for transmission in LCG2 may be determined based on both “Table Information m” and “Buffer Size m”.

Some other embodiments refer to MAC PDU formats similar to those in FIGS. 11A-11C. The LCG in the MAC CE in the embodiments of FIGS. 11A-11C may be replaced by the LCH in these embodiments. For example, the “LCGᵢ” field in FIGS. 11A-11C is replaced by “LCHᵢ” field, to indicate the presence of the BS field and/or the Table Information field for the LCH i. Accordingly, “TBᵢ” field in FIG. 11B indicates the presence of the Table Information field for the LCH i.

In some embodiments using the MAC PDU formats as shown in FIGS. 11A-11C for an LCG or similar MAC PDU formats for an LCH, operations (X) and (Y) may be performed as follows.

In operations (X), a network transmits a configuration about using an EBSR format to a UE, e.g., by an RRC message or a MAC CE if the UE reports its capability of supporting the EBSR. The configuration may include at least one of:
(1) An indicator which is used to enable the UE to use the EBSR format e.g., for one or more LCGs or for one or more LCHs or for UE. For example, a true value of the indicator presents that the EBSR format including a specific value (e.g., in embodiments of FIG. 11A) or table information (e.g., in embodiments of FIGS. 11B and 11C) is enabled to be used for an LCG or an LCH of the UE or for the UE, while a false value of the indicator presents that the EBSR format is disabled to be used for an LCG or an LCH of the UE or for the UE.
(2) A quantization threshold which is used to judge whether to use the EBSR to include a specific value (e.g., in embodiments of FIG. 11A) or table information (e.g., in embodiments of FIGS. 11B and 11C).

In operations (Y), the UE determines a specific value (e.g., 255 in embodiments of FIG. 11A) or table information (e.g., in Table Information field in embodiments of FIGS. 11B and 11C), to indicate the table information having the BS index in the BS field to indicate the UL data volume for transmission in an LCG or an LCH. For example, a UE may dynamically select enhanced buffer status and buffer status for an LCG or an LCH, even if the LCG or the LCH is allowed to use an EBSR by an RRC message. The UE may indicate which is selected for the LCG or the LCH in the EBSR. In this embodiment, a UE may determine whether to use an EBSR or a BSR for an LCG or an LCH based on one of:
(3) it is up to the UE's implementation; or
(4) it is pre-defined in the protocol (or specification) or configured by RRC signaling, if the legacy BSR format introduces the quantization error higher than or equal to a quantization threshold.

In some embodiments, if at least one legacy buffer status is determined for a first LCH or a first LCG and one enhanced buffer status is determined for a second LCH or a second LCG, a UE only uses the EBSR format for all the LCHs (or in all LCGs). In some further embodiments, the EBSR includes the legacy BS for the first LCH or the first LCG and includes the enhanced buffer status having the table information and a BS field for the second LCH or the second LCG. In some other embodiments, the EBSR includes the legacy BS for the first LCH or the first LCG and includes the enhanced buffer status having the table information and a BS field for all the LCHs or all the LCGs. If an UL grant is not enough to include an EBS for an LCG or LCH, the whole EBS may be not included in the MAC PDU to be transmitted even part of the EBS can be included.

In some embodiments of the subject application, a UE transmits the delay information (DI) corresponding to a PDU set (e.g., a frame) in an EBSR to the network, in order to assist the network to determine the available or remaining or left delay budget corresponding to the first arrival PDU or the last arrival PDU in the PDU set (with the highest delay or with the lowest delay budget or with the earliest arriving timing at an AS layer of the first or last reception of a PDU) with the highest priority logical channel in an LCG with or without data available for transmission (or with an LCH with or data without available for transmission). For instance, the DI may include one of:
(1) delay corresponding to the first or last PDU in a PDU set;
(2) left delay budget corresponding to the first or last PDU in a PDU set; or
(3) arriving timing at the AS layer of the first or last PDU in a PDU set.

FIGS. 12A-12C illustrate exemplary MAC PDUs related to an EBSR for an LCH in accordance with some embodiments of the subject application.

As shown in FIGS. 12A-12C, a field in the MAC subheader is used to identify the EBSR, for example, a new LCH ID or a new field with value 1. The MAC CE including enhanced buffer status in FIGS. 12A-12C may include:
(1) LCID: this field identifies the logical channel whose delay is being reported. The data available for transmission definition can be referenced in TS 38322 and TS38.323.
(2) Buffer Size (BS): this field identifies the total amount of data available of a PDU set corresponding to the Delay Information field or the total amount of data available according to the data volume calculation procedure in 3GPP TS38.322 and TS38.323 in one LCH after the MAC PDU has been built (i.e., after the logical channel prioritization procedure, which may result the value of the BS field to be zero). Different from FIGS. 12A and 12B, the MAC CE in FIG. 12C includes “Buffer Size 1” and “Buffer Size 2”. The UL data volume for transmission in the LCH as indicated in the LCID field may be calculated based on these two buffer sizes, e.g., a sum of “Buffer Size 1” and “Buffer Size 2”.
(3) “Delay Information (DI)”: this field indicates the delay information corresponding to the first or last reception of a PDU in a PDU set with the highest delay or with the lowest delay budget or with the earliest arriving timing at an AS layer of the first or last reception of a PDU for the LCH (with or without data available for transmission) after the MAC PDU has been built.
   1) The DI field may be:
      (a) Code index, e.g., 1 presents 2 ms, 2 presents 2.5 ms, and 3 presents 3 ms; or
      (b) Absolute value, e.g., 1 ms, 1.5 ms, 2 ms, 2.5 ms, or 3 ms. A ms is a millisecond.
   2) This field is shown as “Remaining PDU Set Delay Budget”, “Remaining PDU Set Delay Budget 1”, or “Remaining PDU Set Delay Budget 2” in FIGS. 12A-12C. Different from FIGS. 12A and 12C, the MAC CE in FIG. 12B includes “Remaining PDU Set Delay Budget 1” and “Remaining PDU Set Delay Budget 2”. The remaining PDU Set delay budget for the LCH as indicated in the LCID field may be calculated based on these two delay budgets, e.g., a sum of “Remaining PDU Set Delay Budget 1” and “Remaining PDU Set Delay Budget 2”.
(2) Frame identification (ID): this field is optional in the MAC CE in FIGS. 12A-12C. This field indicates the frame corresponding to the enhanced buffer status. The frame ID may be:
   1) Frame Sequence Number (SN); or
   2) Code index, e.g., 0 presents a current frame being transmitted, and 1 presents a next frame to be transmitted.

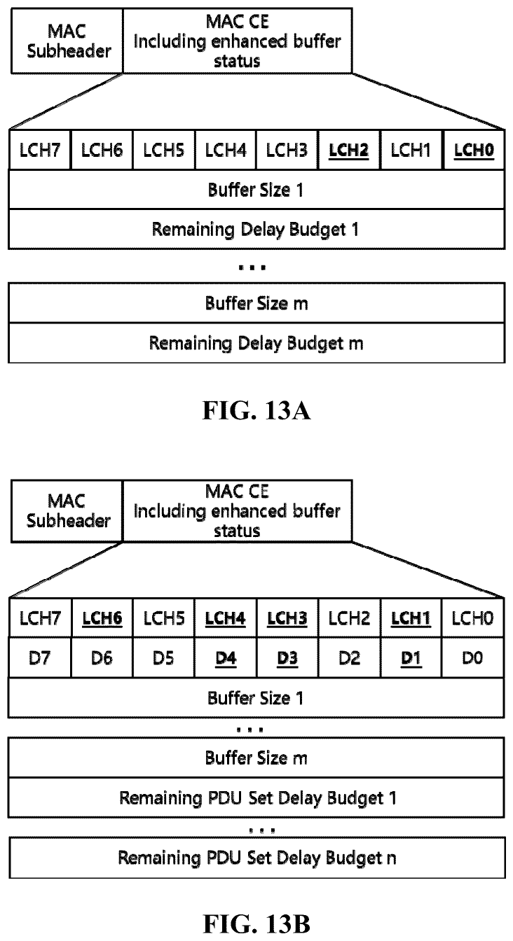

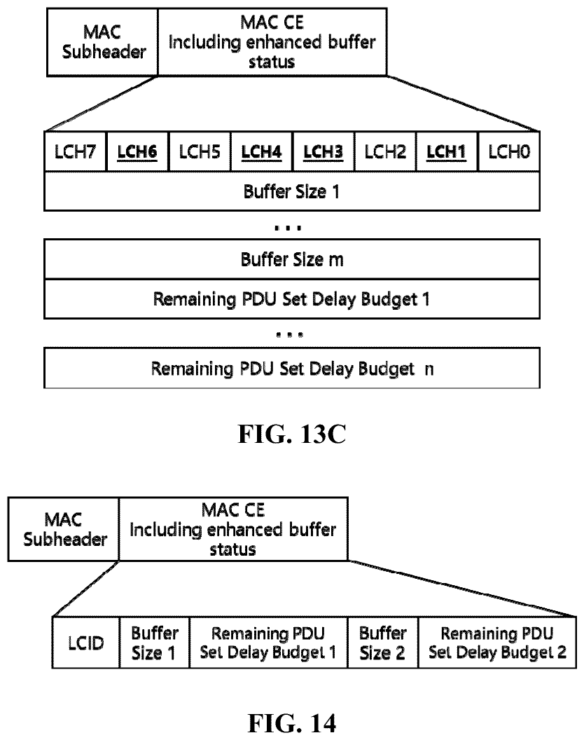

FIGS. 13A-13C illustrate exemplary MAC PDUs related to an EBSR for one or more LCHs in accordance with some embodiments of the subject application. As shown in any of FIGS. 13A-13C, a field in the MAC subheader is used to identify the EBSR, for example, a new LCH ID or a new field with value 1. The MAC CE including enhanced buffer status in any of FIGS. 13A-13C may include the DI field and the BS field, which are the same as those in FIGS. 12A-12C. The DI field in any of FIGS. 13A-13C is shown as “Remaining PDU Set Delay Budget 1” or “Remaining PDU Set Delay Budget m” or “Remaining PDU Set Delay Budget n”.

The MAC CE in any of FIGS. 13A-13C may further include:
(1) LCHi: For the Long EBSR format, this field indicates the presence of the DI field for the LCH i. The LCHi field set to 1 indicates that the BS field and the DI field for the LCH i is reported. The LCHi field set to 0 indicates that the BS field and DI field for the LCH i is not reported. For the long truncated EBSR format, this field indicates whether the LCH i has data available and/or LCH I has DI available. The LCHi field set to 0 indicates that the LCH i does not have data available and/or does not have DI available. For the long EBSR format and the long truncated EBSR format, the EBS with the DI fields for one or more LCHs in any of FIGS. 13A-13C may be included in an ascending order based on the LCHi.

For example, as shown in FIG. 13A, LCH0 and LCH2 are set to 1, to indicate that two pairs the BS and DI fields corresponding to LCH0 and LCH2 are included in the MAC CE. For instance, “Buffer Size 1” and “Remaining PDU Set Delay Budget 1” correspond to LCH0. That is, in the embodiments of FIG. 13A, the BS and DI fields for the LCHs are interleaved.

The MAC CE including enhanced buffer status in FIG. 13B may further include:
(1) Dᵢ: this field corresponds to the LCHi field in the MAC CE. Value 1 of the Dᵢ field indicates the presence of the DI (Delay Information) field of the LCHi. Value 0 of the Dᵢ field indicates the non-presence of the DI field of the LCHi. The Dᵢ fields are included in an ascending order based on the LCHi field with the Di fields set to 1.

For example, as shown in FIG. 13B, LCH1, LCH3, LCH4, and LCH6 are set to 1, to indicate that “Buffer Size 1” to “Buffer Size m” are included in the MAC CE. D0 corresponding to LCH0 is set to 1, to indicate that the table information field of LCH0 is not present. D1 corresponding to LCH1 is set to 1, to indicate that the DI (Delay Information) field of LCHI is present, i.e., “Remaining PDU Set Delay Budget 1”. D3 corresponding to LCH3 is set to 1, to indicate that the DI field of LCH3 is present, i.e., “Remaining PDU Set Delay Budget x” (not shown in FIG. 13B). D4 corresponding to LCH4 is set to 1, to indicate that the DI (Delay Information) field of LCH4 is present, i.e., “Remaining PDU Set Delay Budget n”.

In the embodiments of FIG. 13C, a value of the LCHi field indicates both BS and DI (Delay Information) fields are present or not. If present, both the BS and DI fields corresponding to the LCHi are included in an ascending order of the LCHi. For example, as shown in FIG. 13C, LCH1, LCH3, LCH4, and LCH6 are set to 1, to indicate that “Buffer Size 1” to “Buffer Size m” are included in the MAC CE. Following the “Buffer Size m” corresponding to LCH6, the DI fields corresponding to LCH1, LCH3, LCH4, and LCH6 (e.g., “Remaining PDU Set Delay Budget 1” corresponds to LCH1, and “Remaining PDU Set Delay Budget n” corresponds to LCH6) are included in the MAC CE in an ascending order of the LCHi.

Some other embodiments refer to MAC PDU formats similar to those in FIGS. 13A-13C. The LCH in the MAC CE in the embodiments of FIGS. 13A-13C may be replaced by the LCG in these embodiments. For example, the “LCHᵢ” field in FIGS. 13A-13C is replaced by “LCGᵢ” field, to indicate the presence of the BS field and/or the DI field for the LCG i. Accordingly, “Dᵢ” field in FIG. 13B indicates the presence of the DI field for the LCG i. Accordingly, the “Buffer Size m” is used indicate the data volume available for transmission across all the LCHs in an LCG.

FIG. 14 illustrates an exemplary MAC PDU related to an EBSR for one or more LCHs in accordance with some embodiments of the subject application. As shown in FIG. 14, a field in the MAC subheader is used to identify the EBSR, for example, a new LCH ID or a new field with value 1. The MAC CE including enhanced buffer status in FIG. 14 may include the LCID field and the BS field, which are the same as those in FIGS. 12A-12C. The MAC CE in FIG. 14 may further include:
(1) Delay Information (DI): this field indicates the delay information corresponding to the first or last reception of a PDU in each PDU set for the LCH (with or without data available for transmission) after the MAC PDU has been built. The DI fields are included in an ascending order based on the delay budget or in a decreasing order based on the delay or in an ascending order based on arriving timing at an AS layer of the first or last reception of a PDU. In some embodiments, the DI fields and the BS field corresponding to the DI field are interleaved. For example, as shown in FIG. 14, Buffer Size 1, Remaining PDU Set Delay Budget 1, Buffer Size 2, and Remaining PDU Set Delay Budget 2 are interleaved.

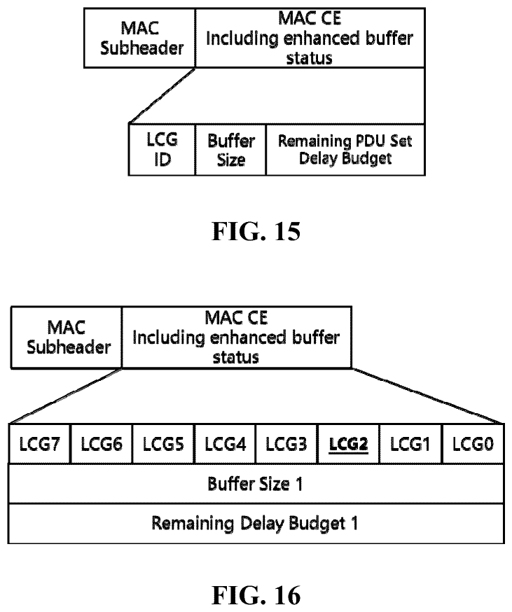

FIG. 15 illustrates an exemplary MAC PDU related to an EBSR for an LCG in accordance with some embodiments of the subject application. FIG. 15 shows an example of one pair of DI and BS fields for one LCG in in short EBSR or short truncated EBSR. As shown in FIG. 15, a field in the MAC subheader is used to identify the EBSR, for example, a new LCH ID or a new field with value 1. The MAC CE including enhanced buffer status in FIG. 15 may include:
(1) LCG ID: this field identifies the group of logical channel(s) whose EBSR is being reported.
(2) Buffer Size (BS): this field identifies the total amount of data available of a PDU set to transmitted corresponding to the DI field or the total amount of data available across all LCHs of an LCG after the MAC PDU has been built (i.e., after the logical channel prioritization procedure, which may result the value of the BS field to be zero).
(3) Delay Information (DI): this field indicates the delay information corresponding to the first or last reception of a PDU in a PDU set (with the highest delay or with the lowest delay budget or with the earliest arriving timing at the AS layer of the first or last reception of a PDU) with the highest priority logical channel (with or without data available for transmission) in the LCG i. For the long EBSR format and the long truncated EBSR format, the DI fields are included in ascending order based on the LCG i. For the long truncated BSR format, this field indicates whether the LCG i has data available.

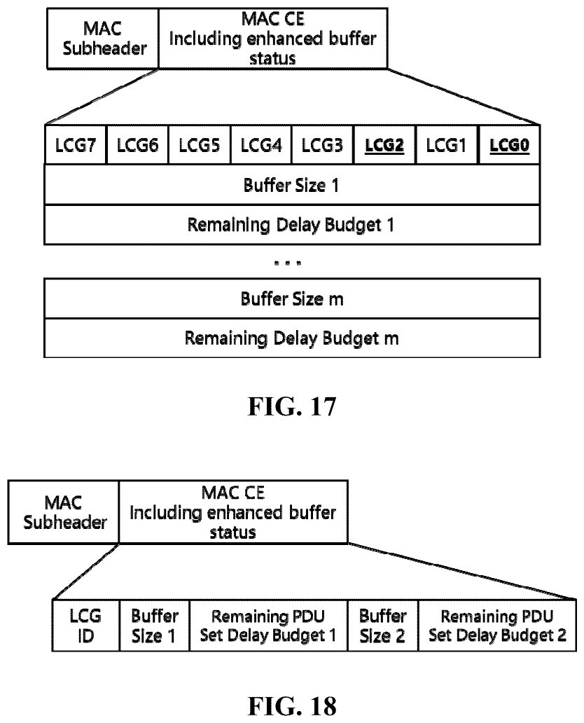

FIGS. 16 and 17 illustrate exemplary MAC PDUs related to an EBSR for an LCG in accordance with some embodiments of the subject application. FIG. 16 shows an example of one pair of DI and BS fields for one LCG in long truncated EBSR format. FIG. 17 shows an example of one pair of DI and BS fields for two or more LCGs in long EBSR format. As shown in FIGS. 16 and 17, a field in the MAC subheader is used to identify the EBSR, for example, a new LCH ID or a new field with value 1. The MAC CE including enhanced buffer status in FIGS. 16 and 17 may include the DI field and the BS field, which are the same as those in FIG. 15. The MAC CE in FIGS. 16 and 17 may further include:
(1) LCGi:
   1) For the long truncated DR format in FIG. 16, this field indicates whether the LCG i has data available. The LCGi field set to 1 indicates that the LCG i has data available. The LCGi field set to 0 indicates that the LCG i does not have data available.
   2) For the long EBSR format in FIG. 17, this field indicates the presence of the DI field for the LCG i. The LCGᵢ field set to 1 indicates that the BS field and the DI field for the LCG i is reported. The LCGᵢ field set to 0 indicates that the BS field and the DI field for the LCG i is not reported.
   3) For the long EBSR format in FIG. 16 and the long truncated EBSR format in FIG. 17, the DI fields may be included in an ascending order based on the LCGi field.

FIG. 18 illustrates exemplary MAC PDUs related to an EBSR for an LCG in accordance with some embodiments of the subject application. FIG. 18 shows an example of two pair of DI and BS fields for one LCG in long EBSR. The MAC CE including enhanced buffer status in FIG. 18 include the LCGᵢ field which is the same as those in FIGS. 16 and 17, and include the BS field which is the same as those in FIG. 15. The MAC CE including enhanced buffer status in FIG. 18 may include:
(1) Delay Information (DI): this field indicates the delay information corresponding to (the first or last reception of a PDU in) a PDU set with the highest priority logical channel (with or without data available for transmission) in the LCG after the MAC PDU has been built.
   1) The DI fields may be included in an ascending order based on the delay budget or in a decreasing order based on the delay or in an ascending order based on arriving timing at an AS layer of the first or last reception of a PDU.
   2) The DI fields and the BS fields corresponding to the DI fields may be interleaved. For example, as shown in FIG. 18, Buffer Size 1, Remaining PDU Set Delay Budget 1, Buffer Size 2, and Remaining PDU Set Delay Budget 2 are interleaved.

In some embodiments of the subject application, if the UL grant is not enough to include all the EBSR of all the LCG, a UE may prioritize the EBSR including a pair of the buffer status information and delay status information in a decreasing order of the logical channel priority, and optionally further in a decreasing order of delay (or in an increasing order of remaining delay budget, or in an increasing order of arriving timing at the AS layer of the first or last reception of a PDU).

In some embodiments, there may be following operations:

For Regular and Periodic EBSR, the MAC entity shall:

| 1> | if more than one LCG or LCH has data (and/or DI) available for | |
|---|---|---|
| | transmission when the MAC PDU containing the EBSR is to be built: | |
| | 2> | report Long EBSR for all LCGs or LCHs which have data available for |
| | | transmission. |
| 1> | else: | |
| | 2> | report Short EBSR. if more than one LCG or LCH has |

For Padding EBSR, the MAC entity shall:

| 1> | if the number of padding bits is equal to or larger than the size of the Short | |
|---|---|---|
| | EBSR plus its subheader but smaller than the size of the Long EBSR plus its | |
| | subheader: | |
| | 2> | if more than one LCG or LCH has data available (and/or DI) for |
| | | transmission when the EBSR is to be built: |

| | |
|---|---|
| 3> | if the number of padding bits is equal to the size of the Short EBSR |
| | plus its subheader: |

| | |
|---|---|
| 4> | report Short Truncated EBSR of the LCG or LCH with the highest |
| | priority logical channel with data available for transmission, and in |
| | case of equal priority, may optionally report Short Truncated EBSR |
| | of the LCG or LCH with the minum remaining delay budget (or |
| | with the maximum delay or with the earlist arriving timing at the AS |
| | layer of the first or last reception of a PDU). |

| | |
|---|---|
| 3> | else: |

| | |
|---|---|
| 4> | report Long Truncated EBSR of the LCG(s) or LCH(s) with the |
| | logical channels having available for transmission following a |
| | decreasing order of the highest priority logical channel (with or |
| | without data available for transmission) in each of these LCG(s) or |
| | LCH(s), and in case of equal priority, may optionally in an |
| | increasing order of the remaining delay budget (or in a decreasing |
| | order of the delay or in ascending order based on arriving timing at |
| | the AS layer of the first or last reception of a PDU) in each of these |
| | LCG ID or LCH ID, and in case of equal priority and in case of |
| | equal remaining delay budget (or in case of equal delay, or in case |
| | of equal arriving timing at the AS layer), in an increasing order of |
| | LCG ID or LCH ID. |

In some embodiments of the subject application, e.g., in any of FIGS. 12A-18, if the UL grant is not enough to include an EBSR of one LCG (or one LCH) but only enough to include a BS field or a DI field of the LCG (or one LCH), a UE may only include the BS field or may only include the DI field or include neither of the BS field nor the DI field in different cases. In case that a BS field or a DI field is not included in the EBSR, an indicator may be included in the EBSR to indicate that there are available values in the BS field and/or the DI field of the LCG (or one LCH) for transmission. If the value in the BS field of the LCG (or one LCH) is transmitted while a value in the DI field of the LCG (or one LCH) is not transmitted due to the UL grant size, in an embodiment, the DI report (i.e., the delay information) of the LCG (or one LCH) may be cancelled for simplicity or not cancelled for late transmission, or in another embodiment, the EBSR of the LCG (or one LCH) for both the buffer status and delay information may be cancelled for simplicity or not cancelled for late transmission even if the value in the BS field of the LCG (or one LCH) has been transmitted. Otherwise, if the value in DI field of the LCG (or one LCH) is transmitted while a value in the BS field of the LCG (or one LCH) is not transmitted due to the UL grant size, in an embodiment, the buffer status report (i.e., the buffer size) of the LCG (or one LCH) may be cancelled for simplicity or not cancelled for late transmission. In another embodiment, the EBSR of the LCG (or one LCH) for both the buffer status and delay information may be cancelled for simplicity or not cancelled for late transmission even if the value in the DI field of the LCG (or one LCH) has been transmitted.

In some embodiments of the subject application, e.g., in any of FIGS. 12A-18, if the UL grant is not enough to include an EBSR of all LCG(s), a UE may include in order of the BS field of all LCGs with the logical channels having data available for transmission, the DI field of all the LCG(s) with the logical channels having data available for transmission or having delay information available for transmission. For example, the UE may first include the BS of the LCG(s) or LCH(s) with the logical channels having available for transmission following a decreasing order of the highest priority logical channel (with or without data available for transmission) in each of these LCG(s) or LCH(s), then include the DI of the LCG(s) or LCH(s) with the logical channels having data available or delay information for transmission following a decreasing order of the highest priority logical channel (with or without data available for transmission) in each of these LCG(s) or LCH(s). In this case, the BS fieds of all LCG(s) or LCH(s) are considered higher priorty than the DI fields of all LCG(s) or LCH(s). In some cases, if the UL grant is not enough to include an EBSR of all LCG(s), a UE may include in order of the DI field of all LCGs with the logical channels having data available for transmission, the BS field of all the LCG(s) with the logical channels having data available for transmission or having delay information available for transmission. In this case, the priority of DI is considered higher than BS filed for all LCGs or all LCHs. In another case, the priority of BS and DI of the one LCG or one LCH is determined based on the logical channel priority or the highest logical channel priority in the LCG. UE may include the BS field or DI field of the LCG(s) or LCH(s) with the logical channels having available for transmission following a decreasing order of the highest priority logical channel (with or without data available for transmission) in each of these LCG(s) or LCH(s). For example, LCG 0 (or LCH 2) only has BS for transmission, LCG2 (or LCH 2) only has DI for transmission, if the highest logical channel of the LCG 0 (or LCH 0) is higher than the highest logical channel priority in the LCG 2 (or the logical channel priority of LCH 2) and the UL grant only is enough to include BS or DI field, the UE may select include the DI field for LCG2. In any of the above cases, if a BS field or a DI field of an LCG (or an LCH) is not included in the EBSR, an indicator may be included in the EBSR to indicate that there are available values in the BS field and/or the DI field of an LCG (or an LCH) for transmission.

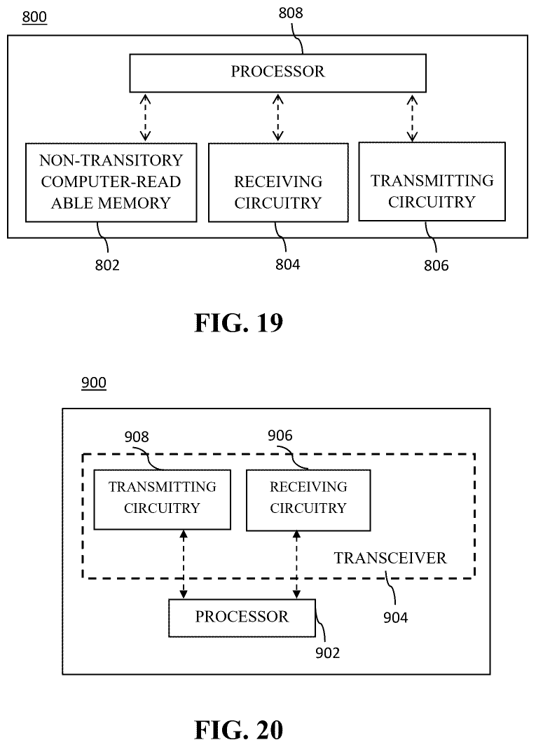

FIG. 19 illustrates an exemplary block diagram of an apparatus 800 for a data discarding operation in accordance with some embodiments of the subject application. As shown in FIG. 19, the apparatus 800 may include at least one non-transitory computer-readable medium 802, at least one receiving circuitry 804, at least one transmitting circuitry 806, and at least one processor 808 coupled to the non-transitory computer-readable medium 802, the receiving circuitry 804 and the transmitting circuitry 806. The at least one processor 808 may be a CPU, a DSP, a microprocessor etc. The apparatus 800 may be a network node (e.g., a base station) or a UE configured to perform a method illustrated in the above or the like.

Although in this figure, elements such as the at least one processor 808, receiving circuitry 804, and transmitting circuitry 806 are described in the singular, the plural is contemplated unless a limitation to the singular is explicitly stated. In some embodiments of the subject application, the receiving circuitry 804 and the transmitting circuitry 806 can be combined into a single device, such as a transceiver. In certain embodiments of the subject application, the apparatus 800 may further include an input device, a memory, and/or other components.

In some embodiments of the subject application, the non-transitory computer-readable medium 802 may have stored thereon computer-executable instructions to cause a processor to implement the methods with respect to a UE or a network node (e.g., a base station) as described or illustrated above. For example, the computer-executable instructions, when executed, cause the processor 808 interacting with receiving circuitry 804 and transmitting circuitry 806, so as to perform the steps with respect to a UE or a network node (e.g., a base station) as described or illustrated above.

FIG. 20 illustrates a further exemplary block diagram of an apparatus 900 for a data discarding operation in accordance with some embodiments of the subject application. Referring to FIG. 20, the apparatus 900, for example a BS or a UE, may include at least one processor 902 and at least one transceiver 904 coupled to the at least one processor 902. The transceiver 904 may include at least one separate receiving circuitry 906 and transmitting circuitry 908, or at least one integrated receiving circuitry 906 and transmitting circuitry 908. The at least one processor 902 may be a CPU, a DSP, a microprocessor etc.

According to some other embodiments of the subject application, when the apparatus 900 is a UE, the processor 902 may be configured to: receive, via the transceiver 904 from a network, a configuration for enabling a function of an EBSR; and transmit the EBSR via the transceiver 904 to the network.

According to some embodiments of the subject application, when the apparatus 900 is a network node (e.g., a base station), the processor 902 is configured to: transmit, via the transceiver 904 to a UE, a configuration for enabling a function of an EBSR; and receive the EBSR via the transceiver 904 from the UE.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1.-15 (canceled)

16. A user equipment (UE) for wireless communication, comprising:
at least one memory; and
at least one processor coupled with the at least one memory and configured to cause the UE to:
receive, from a network, a first configuration for enabling a function of an enhanced buffer status report (EBSR);
receive a third configuration related to one or more buffer size (BS) tables for a logical channel group (LCG) or a logical channel (LCH) from the network, and wherein a BS index included in the EBSR is selected from the one or more BS tables; and
transmit the EBSR to the network.

17. The UE of claim 16, wherein the EBSR includes at least one of:
one or more delay information (DI) fields including delay information associated with one or more protocol data unit (PDU) sets;
one or more BS fields including one or more BS indexes associated with the delay information; or
an LCG i field that indicates a presence of a BS field and a DI field for the LCG i.

18. The UE of claim 17, wherein one or more buffer sizes indicated by the one or more BS indexes represent:
a total amount of data available for transmission in the one or more PDU sets corresponding to the delay information; or a total amount of data available for transmission in an LCH; or
a total amount of data available for transmission across all LCHs of an LCG.

19. The UE of claim 17, wherein the one or more DI fields and the one or more BS fields for an LCH or an LCG are interleaved in the EBSR to form one or more pairs of DI fields and BS fields.

20. The UE of claim 19, wherein the one or more DI fields within the one or more pairs for the LCH or the LCG are ordered:
in an ascending order based on a remaining PDU set delay budget;
in a decreasing order based on a PDU set buffer delay;
in an ascending order based on arriving timing at an access stratum (AS) layer of the UE of a first arrival PDU; or
in an ascending order based on arriving timing at the AS layer of the UE of a last arrival PDU.

21. The UE of claim 19, wherein, in response to allocated uplink (UL) resources being not sufficient to accommodate the one or more pairs in the EBSR for one LCG, the at least one processor is further configured to cause the UE to:
not include the BS field and the DI field for the LCG.

22. The UE of claim 16, wherein the third configuration includes an indicator used to enable the UE to use the EBSR format for one or more LCGs.

23. The UE of claim 16, wherein the at least one processor is further configured to cause the UE to: dynamically select an enhanced buffer status or a buffer status for an LCG when the LCG is allowed to use the EBSR via a radio resource control (RRC) message and indicate the dynamically selected enhanced buffer status or buffer status for the LCG in the EBSR.

24. The UE of claim 16, wherein, when at least one legacy buffer status is determined for a first LCG and one enhanced buffer status is determined for a second LCG, the at least one processor is further configured to cause the UE to use the EBSR format for all LCGs.

25. The UE of claim 16, wherein the EBSR includes a sixth field having a value that indicates whether a fifth field of one LCG is present in the EBSR, wherein the fifth field indicates information of a buffer size table for the one LCG.

26. The UE of claim 16, wherein the EBSR includes a fifth field i corresponding to an LCG i, which is set to 0 to indicate a buffer size index of the LCG i is in a legacy 8 bits buffer size index table.

27. The UE of claim 16, wherein the EBSR includes a first field corresponding to an LCG i, which is set to a specific value, a buffer size corresponding to the LCG i is in a new BS index table.

28. The UE of claim 16, wherein the EBSR is a delay status report.

29. A network node for wireless communication, comprising:
at least one memory; and
at least one processor coupled with the at least one memory and configured to cause the network node to:
transmit, to a user equipment (UE), a first configuration for enabling a function of an enhanced buffer status report (EBSR);
transmit, to the UE, a third configuration related to one or more buffer size (BS) tables for a logical channel group (LCG) or a logical channel (LCH), wherein a buffer size index included in the EBSR is selected from the one or more BS tables;
and
receive the EBSR from the UE.

30. A method performed by a network node, the method comprising:
transmitting, to a user equipment (UE), a configuration for enabling a function of an enhanced buffer status report (EBSR); and
receiving the EBSR from the UE.

31. A user equipment (UE) for wireless communication, comprising:
at least one memory; and
at least one processor coupled with the at least one memory and configured to cause the UE to:
transmit an enhanced buffer size report (EBSR) to a network;
wherein the EBSR includes at least one of:
one or more delay information (DI) fields including delay information associated with one or more protocol data unit (PDU) sets;
one or more buffer size (BS) fields including one or more BS indexes associated with the delay information; or
a logical channel group (LCG) i field that indicates a BS field and a DI field for a LCG i.

32. The UE of claim 31, wherein the EBSR includes a sixth field having a value that indicates whether a fifth field of one LCG is present in the EBSR, wherein the fifth field indicates information of a buffer size table for the one LCG.

33. The UE of claim 31, wherein the EBSR includes a fifth field i corresponding to the LCG i, which is set to 0 to indicate a buffer size index of the LCG i is in a legacy 8 bits buffer size index table.

34. The UE of claim 31, wherein the EBSR includes a first field corresponding to the LCG i, which is set to a specific value, and wherein a buffer size corresponding to the LCG i is in a new BS index table.

35. The UE of claim 31, wherein the delay information is corresponding to one PDU set within the one or more PDU sets in an LCG with data available for transmission, or the delay information is corresponding to the first or last reception of a PDU in a PDU set with the lowest delay budget of a PDU in the LCG.
